(19) United States
(12) Patent Application Publication
(10) Pub. No.: US 2025/0352305 A1
(43) Pub. Date: Nov. 20, 2025

(54) FORCE CONTROL, STOP MECHANISM, REGULATING STRUCTURE OF REMOVABLE ARCH ADJUSTMENT APPLIANCE

(71) Applicant: Align Technology, Inc., San Jose, CA (US)

(72) Inventors: Jun SATO, San Jose, CA (US); Yaser SHANJANI, Milpitas, CA (US); Ryan KIMURA, San Jose, CA (US)

(21) Appl. No.: 19/288,809

(22) Filed: Aug. 1, 2025

Related U.S. Application Data
(62) Division of application No. 17/856,920, filed on Jul. 1, 2022.
Application No. 17/856,920 is a division of application No. 15/580,874, filed on Dec. 8, 2017, now Pat. No. 11,376,101.
(60) Provisional application No. 62/429,545, filed on Dec. 2, 2016.

(51) Int. Cl. A61C 7/10; A61C 7/08

(52) U.S. Cl. CPC A61C 7/10; A61C 7/08

(57) ABSTRACT

A removable arch adjustment appliance includes a removable shell having a plurality of cavities formed therein, wherein the plurality of cavities are shaped to receive at least one posterior tooth of a patient on each side of a patient's jaw. The shell can include an elastic transpalatal element that spans a palate of the patient and provides force to expand at least one of the spaces between the posterior teeth on each side of a patient's jaw or the palate of the patient. The transpalatal element can include a predetermined force characteristic, a number of force control elements to control the force provided by the transpalatal element, and/or a regulating structure to balance and direct the force provided by the transpalatal element, wherein the transpalatal element has a width specific to a stage of a treatment plan.

### CROSS REFERENCE TO RELATED APPLICATIONS

This application is a division of U.S. patent application Ser. No. 17/856,920, filed Jul. 1, 2022, titled “FORCE CONTROL, STOP MECHANISM, REGULATING STRUCTURE OF REMOVABLE ARCH ADJUSTMENT APPLIANCE,” now U.S. Patent Application Publication No. 2022/0338958, which is a division of U.S. patent application Ser. No. 15/580,874, filed Dec. 8, 2017, titled “FORCE CONTROL, STOP MECHANISM, REGULATING STRUCTURE OF REMOVABLE ARCH ADJUSTMENT APPLIANCE,” now U.S. Pat. No. 11,376,101, which is a national phase application under 35 USC 371 of International Patent PCT/US2017/064340, filed Dec. 1, 2017, titled “FORCE CONTROL, STOP MECHANISM, REGULATING STRUCTURE OF REMOVABLE ARCH ADJUSTMENT APPLIANCE,” now International Patent Application Publication No. WO 2018/102770, which claims benefit of U.S. Provisional Patent Application No. 62/429,545, filed Dec. 2, 2016, and titled “FORCE CONTROL, STOP MECHANISM, REGULATING STRUCTURE OF REMOVABLE ARCH ADJUSTMENT APPLIANCE,” each of which is herein incorporated by reference in its entirety.

### BACKGROUND

The present disclosure is related generally to the field of dental treatment. More particularly, the present disclosure is related to methods, systems, and devices for adjusting an arch of a patient.

Dental treatments may involve, for instance, restorative and/or orthodontic procedures. Restorative procedures may be designed to implant a dental prosthesis (e.g., a crown, bridge inlay, onlay, veneer, etc.) intraorally in a patient. Orthodontic procedures may include repositioning misaligned teeth and/or changing bite configurations for improved cosmetic appearance and/or dental function. Orthodontic repositioning can be accomplished, for example, by applying controlled forces to one or more teeth over a period of time.

As an example, orthodontic repositioning may be provided through a dental process that uses positioning appliances for realigning teeth. Such appliances may utilize a thin shell of material having resilient properties, referred to as an “aligner,” that generally conforms to a patient's teeth but is slightly out of alignment with a current tooth configuration.

Placement of such an appliance over the teeth may provide controlled forces in specific locations to gradually move the teeth into a new configuration. Repetition of this process with successive appliances in progressive configurations can move the teeth through a series of intermediate arrangements to a final desired arrangement.

Such systems typically utilize materials that are lightweight and/or transparent to provide a set of appliances that can be used serially such that as the teeth move, a new appliance can be implemented to further move the teeth toward the desired goal.

In some instances, the width of a dental arch of a patient's upper dentition can be insufficient (e.g., too narrow). A dental arch that is insufficient can result in malocclusions such as crossbite, crowding of teeth, impacted teeth, and/or the patient's smile may not be aesthetically pleasing in appearance. For instance, a patient's smile may be “narrow”, resulting in a sunken appearance in the buccal corridors due to the inability to see the back teeth from the front view.

In certain types of front-to-back bite correction (e.g., Class II and Class III correction), a need for transverse width correction exists, without which the upper and lower arches may not be properly coordinated. For Class II correction, the upper needs to be expanded so that when the lower is advanced, the teeth in the buccal regions (typically the bicuspids and molars) are fitting together correctly in the buccal-lingual dimension. For Class III correction, the reverse is required, and the lower needs to be expanded since it is usually the one that has compensated for the Class III bite by constricting. When both Class II and Class III are corrected to a more ideal Class I bite, the respective compensations need to be undone, and a transverse width dimension of movement is necessary in addition to the anterior-to-posterior movement.

There are several ways in which the arch of a patient can be expanded. For example, palatal expansion expands the upper jaw of the patient by spreading the maxilla. In some situations, the teeth of the upper jaw can be moved or angled outward thereby expanding the width of the arch of the patient. This technique can be referred to as dental expansion.

In young patients, the midpalatal suture has not fused the left and right maxillary palates together and therefore, the movement of the plates with respect to each other can be accomplished more easily and with less force than in older patients. When the fusing of the suture is new, it may still be possible to split the suture apart.

For example, currently available orthodontic appliances can include a jackscrew and/or other mechanism that is employed to deliver a horizontal stretching force to the molar teeth to split the upper jaw of the patient along the midpalatal suture. Such a mechanism typically spreads the left and right maxillary plates of the palate apart and then new bone material grows in between to fill the gap. As such, a large horizontal force (e.g., 10 to 50 Newtons (N) with cumulative loads reaching 40 to 150 N across the suture) is applied during a short period, in many cases. The insertion of such a mechanism is typically accomplished by a treatment professional and can cause discomfort and/or pain for a patient.

In some instances, the screw and/or other mechanism can be employed incrementally one or more times a day (e.g., 0.25 mm expansion twice a day-one activation in the morning and once at night). For example, a pinhole can be present in the orthodontic appliance and a patient can insert an activation key into the pinhole to incrementally increase a distance between portions of the orthodontic appliance.

Such orthodontic appliances can be difficult for a patient to use, and often require assistance from another person (e.g., a parent) to turn the key. Not only are such appliances often not aesthetically pleasing, they often times interfere with the patient's speech, temporarily affect their ability to chew and/or swallow, and/or can be painful when activated.

Adding to the challenges of such an appliance is the need to retain the expansion while the bone is filling into the suture, long after the active expansion has taken place. The active expansion process may be completed within 2 or 3 weeks' time, but the retention period can last around 6 months while waiting for the gap between the maxillary halves to fill in with new bony tissue.

### BRIEF DESCRIPTION OF THE DRAWINGS

FIG. 1 illustrates an example of a removable arch adjustment appliance having a transpalatal element that includes a number of flexing elements according to a number of embodiments of the present disclosure.

FIG. 2 illustrates an example of a removable arch adjustment appliance having a transpalatal element that includes a number of flexing elements according to the present disclosure.

FIG. 3 illustrates an example of a removable arch adjustment appliance having a transpalatal element that includes a number of flexing elements according to a number of embodiments of the present disclosure.

FIG. 4 illustrates an example of a removable arch adjustment appliance having a transpalatal element that includes a member according to one or more embodiments of the present disclosure.

FIG. 5 illustrates an example of a removable arch adjustment appliance having a transpalatal element that includes two members attached thereto according to one or more embodiments of the present disclosure.

FIG. 6 illustrates an example of a removable arch adjustment appliance having a transpalatal element that includes two members attached thereto according to one or more embodiments of the present disclosure.

FIG. 7 illustrates an example of a removable arch adjustment appliance having a transpalatal element that includes a sliding stop mechanism according to a number of embodiments of the present disclosure.

FIG. 8 illustrates an example of a removable arch adjustment appliance having a transpalatal element that includes a sliding stop mechanism according to a number of embodiments of the present disclosure.

FIG. 9 illustrates an example of a removable arch adjustment appliance having a transpalatal element that includes a tension stop mechanism according to a number of embodiments of the present disclosure.

FIG. 10 illustrates an example of a removable arch adjustment appliance having a transpalatal element that includes a tension stop mechanism according to a number of embodiments of the present disclosure.

FIG. 11 illustrates an example of a removable arch adjustment appliance having a transpalatal element that includes a deflection limit stop mechanism according to a number of embodiments of the present disclosure.

FIG. 12 illustrates an example of a removable arch adjustment appliance having a transpalatal element that includes a deflection limit stop mechanism according to a number of embodiments of the present disclosure.

FIG. 13A illustrates a removable arch adjustment appliance including a regulating structure for a plurality of tooth engagement structures according to a number of embodiments of the present disclosure.

FIG. 13B illustrates a removable arch adjustment appliance including regulating structures for a plurality of tooth engagement structures according to a number of embodiments of the present disclosure.

FIG. 13C illustrates a removable arch adjustment appliance including regulating structures for a plurality of tooth engagement structures according to a number of embodiments of the present disclosure.

FIG. 13D illustrates a removable arch adjustment appliance including regulating structures for a plurality of tooth engagement structures according to a number of embodiments of the present disclosure.

FIG. 13E illustrates a removable arch adjustment appliance including cavities and regulating structures for a plurality of tooth engagement structures according to a number of embodiments of the present disclosure.

FIG. 14 illustrates a removable arch adjustment appliance including a regulating structure comprising a ball joint according to a number of embodiments of the present disclosure.

FIG. 15 illustrates a removable arch adjustment appliance including a regulating structure comprising a universal joint according to a number of embodiments of the present disclosure.

FIG. 16 illustrates a removable arch adjustment appliance including a regulating structure comprising an arm according to a number of embodiments of the present disclosure.

FIG. 17 illustrates a removable arch adjustment appliance including a regulating structure comprising a mesh of arms according to a number of embodiments of the present disclosure.

FIG. 18A illustrates a removable arch adjustment appliance including a regulating structure comprising a horizontal accordion spring according to a number of embodiments of the present disclosure.

FIG. 18B illustrates a removable arch adjustment appliance including a regulating structure comprising a vertical accordion spring according to a number of embodiments of the present disclosure.

FIG. 19 illustrates a removable arch adjustment appliance including a regulating structure comprising a coupling spring according to a number of embodiments of the present disclosure.

FIG. 20 illustrates a removable arch adjustment appliance including regulating structures for individual tooth engagement structures according to a number of embodiments of the present disclosure.

FIG. 21 illustrates a removable arch adjustment appliance including regulating structures for individual tooth engagement structures comprising ball joint s according to a number of embodiments of the present disclosure.

FIG. 22 illustrates a removable arch adjustment appliance including regulating structures for individual tooth engagement structures comprising universal joint s according to a number of embodiments of the present disclosure.

FIG. 23 illustrates a removable arch adjustment appliance including regulating structures for individual tooth engagement structures comprising arms according to a number of embodiments of the present disclosure.

FIG. 24A illustrates a removable arch adjustment appliance including regulating structures for individual tooth engagement structures comprising horizontal accordion springs according to a number of embodiments of the present disclosure.

FIG. 24B illustrates a removable arch adjustment appliance including regulating structures for individual tooth engagement structures comprising vertical accordion springs according to a number of embodiments of the present disclosure.

FIG. 25 illustrates a removable arch adjustment appliance including regulating structures for individual tooth engagement structures comprising coupling springs according to a number of embodiments of the present disclosure.

FIG. 26 illustrates an example computing device readable medium having executable instructions that can be executed by a processor to perform a method according to one or more embodiments of the present disclosure.

### DETAILED DESCRIPTION

As discussed above, the present disclosure provides methods, systems, and devices for expanding an arch of a patient. As used herein, expanding a dental arch can include dental and/or skeletal expansion and is inclusive of both dental arch expansion and palatal expansion. Such expansion can be part of an orthodontic treatment, which is a process of moving and reorienting teeth for functional and/or aesthetic purposes, although expansion can be provided for other purposes. The expansion of the dental arch can include movement of posterior teeth (e.g., molars) and/or other teeth of the dental arch in a transverse direction and/or stretching of the maxillary suture of the patient (e.g., separating the maxillary halves in the region of the suture), along with a stretching of the surrounding soft tissues (e.g., the palatal gingiva) during the expansion. A transverse direction in this context is outward along the arch.

Some orthodontic treatment plans can include a dental arch expansion process. Such a process typically occurs in an early stage of the plan in order to provide more room for the teeth to be arranged. A narrow dental arch can prevent the anterior-posterior bite relationship from being corrected properly during orthodontic treatment. A dental arch, as used herein, can include a curved row of teeth on a particular jaw of a patient. An insufficient dental arch can include a dental arch that has a width too narrow to support the row of teeth in a correct alignment.

A narrow arch can also prevent the anterior-posterior bite relationship from being corrected properly. An arch of teeth, as used herein, can include a curved row of teeth on a particular jaw of a patient. An insufficient arch can include an arch that has a width too narrow to support the row of teeth in a correct alignment, for instance. The arch width of a patient's teeth can be expanded, for instance, using an orthodontic appliance (e.g., a dental appliance).

As discussed above, patients that are children or teenagers may have a maxilla where the midpalatal suture has not yet fused. Usually in the mid to late teens, the palatal suture fuses and the halves of the maxilla join together to become a single maxillary bone.

The maxilla (e.g., the upper jaw) is a bone that is fixed to the skull and forms the palate of the patient. The mandible (e.g., lower jaw) is a bone that is also attached to the skull by numerous muscles that power its movement. The mandible articulates at its posterior upward extremities with the temporal bone to form the jaw joint. The jaw joint is a loosely connected joint that accommodates the variety of movements of the mandible relative to the maxilla during biting and chewing.

In correctly shaped and positioned jaws, the upper teeth occupy an arch that is wider than the arch comprising the lower teeth. In other words, the upper teeth are designed to be buccally positioned relative to the teeth in the lower jaw. Malocclusions, such as crossbite, occur when this normal arrangement is reversed and one or more of the upper teeth are positioned lingual to the teeth in the lower jaw.

A patient with an un-fused maxilla can, for instance, have their palate skeletally expanded. This is in contrast to dental expansion where the teeth are uprighted or moved within the boundaries of the jaw in which they are contained. With skeletal expansion, the underlying bone is moved and the teeth are moved along with the changes to the shape of the bone.

Expanding a palate can, for instance, include splitting the left and right sides of the maxilla so that the teeth on the upper left side move as a single unit relative to the teeth on the right side. Because of this phenomenon, a gap between the top two front teeth can open up during the expansion process if they are not restrained from separating.

As discussed above, expansion of the palate, such as those methods performed prior to an orthodontic treatment involving braces and wires, currently includes having a treatment professional place an orthodontic appliance that may include anchoring bands, support bars, springs, and/or jack screws. The appliance is firmly affixed to the teeth at the anchor points and the springs or jackscrew applies forces on the teeth in order to move the underlying portions of the palate of the patient, thereby causing the arch of the patient's dentition to widen.

To adjust the appliance and increase the amount of expansion, the patient and/or another person can insert a key into the pinhole and turn the key to increase the width of the orthodontic appliances. In some examples, prior approaches can include a removable appliance which contains a jackscrew expander that is activated with a pinhole key.

After expanding the arch of the patient to the desired width (and sometimes overcorrecting in order to anticipate potential relapse toward the narrowness initially present), further orthodontic treatment can be performed to move and re-orient the teeth of the patient. This type of additional orthodontic treatment is typically performed after the expansion phase and a retention period where the jaw position is stabilized for a period of time while the musculature and bone adjust to the new positioning.

Further, palate expansion devices that are used primarily for skeletal expansion are typically temporarily anchored to posterior teeth, which can include the molars and/or pre-molars of the patient for the duration of the expansion and cannot be removed except by a dental professional because they are cemented into place. The forces that are applied to the molars and/or premolars are rather high in order to separate the suture during a short time period (e.g., one or more days), and therefore, the treatment can be uncomfortable to the patient due to the high pressure that is generated during the activation period. Once the suture splits, the majority of the pressure is relieved and subsequent activations in close proximity to the initial activation are not as uncomfortable.

In contrast, expanding an arch of a patient (whether skeletally with a fixed appliance or dentally with a removable appliance) according to embodiments of the present disclosure, can include utilizing a set of one or more appliances, such as positioners, retainers, and/or other removable appliances (e.g., clear plastic polymer shells and/or aligners) having a shell to be worn over the teeth of a patient and having a transpalatal element thereon that is designed to expand an arch of teeth of the patient by: moving the teeth of the patient to a wider position within the jaw; by expanding the palate of the patient; or a combination of the two. A transpalatal element can extend from the removable shell and across at least a portion of the arch width of the removable shell. The arch width can be from molar to molar, from premolar to premolar, from canine to canine, or from any tooth on the left side to any tooth on the right side. For example, in transpalatal elements, the transpalatal element can extend across the palate (trans-palatal) and can extend across at the posterior, anterior, in parts of one or the other, or in both areas of the patient's mouth.

Palatal expansion may be accomplished, for example, by force driven appliances. As used herein, force driven appliances can include appliances that use a calculated force to expand an arch and/or a palate of a patient by a threshold distance. For instance, the transpalatal element of an appliance can expand an arch and/or a palate of a patient by providing a calculated force on the teeth of the patient to expand an arch and/or a palate of a patient by a threshold distance. However, force driven palatal expansion can result in over expansion of the arch and/or palate of the patient. Therefore, controlling the force provided by the appliance by utilizing force control elements and/or using stop mechanisms to stop the expansion of the appliance at a predetermined threshold distance may aid in preventing over expansion of the arch and/or palate of the patient.

One or more appliance embodiments can include a removable shell formed of a first material having a plurality of cavities therein, wherein the cavities are shaped to receive teeth of the patient. These appliances are not fixed to the teeth of the patient and therefore can be removed by the patient for periods of time during treatment without aid from other people or intervention by a treatment professional.

In some instances, applying an expansion force to multiple teeth via tooth engagement structures can result in one or more teeth moving differently than other teeth such that the dental arch expands unequally in an undesired or unplanned manner. In contrast, according to a number of embodiments of the present disclosure, a removable arch adjustment appliance can include regulating structures connected between the transpalatal element and the tooth engagement structures. The regulating structures can be configured to balance and direct the expansion force from the transpalatal element to the tooth engagement structures.

In some embodiments, a transpalatal element of the appliance can be formed of a first material and from a second material that is a different than the first material in at least one physical property. For example, the first material may be a polyurethane material and the second material may also be a polyurethane material with the same chemical formula, but of different hardness or rigidity due to greater crosslinking. Or, the first material can be of one chemical composition (e.g. polyurethane), and the second material of an entirely different chemical composition (e.g. polyvinyl chloride).

In some embodiments, the second material is more resilient than the first material. This can be beneficial in embodiments, for example, where there is an initial need for a more rigid transpalatal element and then a more resilient transpalatal element later in treatment, among other situations where such an embodiment may be utilized.

In some examples, the transpalatal element of the appliance can have a width specific to a stage of a treatment plan and can be designed to expand an arch of the teeth of the patient to that specified width, which may be less than the full width in which that arch is to be expanded (i.e., the arch expansion can be incrementally accomplished by expanding the arch a little distance at a time over the use of several differently designed sequential dental appliances). In some examples, the transpalatal element can include force control elements specific to a stage of a treatment plan and can be designed to expand an arch and/or palate of the patient to a specified width of that stage of the treatment plan, which may be less than the full width in which the arch and/or palate of the patient is to be expanded. In some examples, the transpalatal element can include stop mechanisms that allow expansion of an arch and/or palate of the patient by a predefined expansion length, where the stop mechanisms and/or the predefined expansion length may be specific to a stage of a treatment plan. The predefined expansion length may be less than the full expansion length in which the arch and/or palate of the patient is to be expanded. The expansion length of each stage of the treatment plan may be predefined by a treatment professional.

For example, rather than providing a strong force, such as 10 to 50 N for a short period of a few days to a few weeks, embodiments of the present disclosure can provide a lesser predetermined force, such as 3 to 9 N, for a longer period, such as a month to six months. This force can be used, for example, to move palatal plates, move teeth outward, and/or maintain the teeth and/or jaw in a particular orientation while musculature and bone are adjusting to the orientation and to prevent movement of the teeth or jaw back toward their pre-expansion orientation.

In some embodiments, the second material can include, for instance, a more rigid material than the first material designed to provide greater resistance and/or force in a horizontal direction (i.e., transverse direction) against the posterior teeth (e.g., molars and bicuspids) of the arch of the patient. In various embodiments, this second material can be designed to impart force to the molars and/or other teeth on the jaw of the patient in order to either help preserve or change the transverse dimensions of the arch. Additionally, in some embodiments, with the use of appliances on the upper jaw, the force can be imparted to parts of the opposing jaw (e.g., teeth, jaw bone, etc.).

The expansion of an arch of teeth in the patient can be used to treat malocclusions such as crossbites, sagittal problems, crowding, and/or to help prevent or resolve impacted teeth, in various embodiments. The transverse support elements can be designed to not interfere with the shells of the dental appliance. In this manner, a dental appliance in accordance with embodiments of the present disclosure can be used to concurrently expand or constrict an arch of the patient while also repositioning a number of teeth of the patient.

For example, in some embodiments, the shell of the dental appliance can be used to provide force on one or more teeth to change their location or orientation. Embodiments of the present disclosure can be utilized to treat Class I, Class II, and Class III malocclusions.

For instance, with Class I malocclusions, teeth of the patient are inserted into cavities in the shell and the shell applies force to one or more teeth to change their location or orientations. With Class II (overbite or overjet) and Class III (underbite) malocclusions, the appliance can include other features, such as cut outs (areas cut out of the appliance shell material to allow access to the tooth surface through the appliance or to form, for example, a hook to attach a resilient member (e.g., an elastic band material) between the upper and lower jaw, to for instance treat a overbite or overjet.)

As discussed above, in some embodiments, a plurality of appliances can be worn by a patient successively to achieve gradual expansion (or constriction) of the arch of teeth in the patient. For instance, each of a plurality of dental appliances can include an incrementally wider width to expand the arch of the patient in incremental distances (e.g., expansion lengths). In some such embodiments, since this arch expansion technique can be accomplished concurrently with other orthodontic treatments, the arch expansion can be accomplished over a series of appliances that can be utilized, for example, over a period of less than six months, thereby making any pain and/or discomfort of the patient more consistent and less arbitrary without prolonging the overall time for orthodontic treatment. Additionally, force control elements and/or stop mechanisms can prevent over expansion of the arch and/or palate in any one stage of a treatment plan.

In some embodiments, an appliance can be formed using a thermoforming process. For instance, a transpalatal element of a removable shell can be formed of a material using a virtual model of the palate of the patient and a virtual model of a number of teeth of the patient.

The transpalatal element of a removable shell can be wider than the arch width of the number of teeth of the jaw of the patient and can be shaped to substantially follow contours of the palate of the patient. For expansion, this difference in the width can facilitate the movement of the arch outward toward the wider position of the transpalatal element generating a transverse expansion force.

The removable shell can be formed over a set of molded teeth. The removable shell can include a plurality of cavities formed therein and shaped to receive the number of teeth of patient.

The transpalatal element of a removable shell can, for example, be connected to the removable shell to form the dental appliance. The transpalatal element can be connected, in accordance with various embodiments of the present disclosure, for example, by thermoforming the removable shell over the set of molded teeth with the transpalatal element placed within the set of molded teeth (e.g., encapsulated), or via direct fabrication of the transpalatal element from a virtual model, then by fusing the two materials together (e.g., ultrasonic welding), by adhering the transpalatal element to the removable shell using an agent subsequent to forming the first portion and the removable shell. In this manner, a dental appliance can be formed that has two distinct material properties, but is unitary in nature (e.g., forms a single body that can be used by the patient even though it is formed of two materials).

In the detailed description of the present disclosure, reference is made to the accompanying drawings that form a part hereof, and in which is shown by way of illustration how one or more embodiments of the disclosure may be practiced. These embodiments are described in sufficient detail to enable those of ordinary skill in the art to practice the embodiments of this disclosure, and it is to be understood that other embodiments may be utilized and that process, electrical, and/or structural changes may be made without departing from the scope of the present disclosure. As used herein, “a number of” a particular thing can refer to one or more of such things (e.g., a number of teeth can refer to one or more teeth).

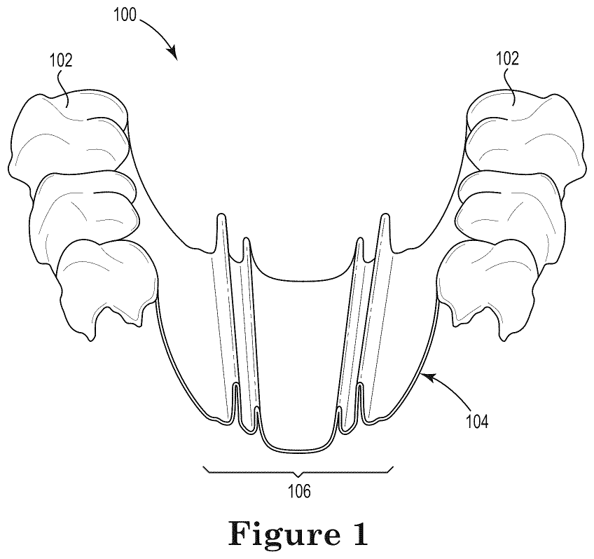

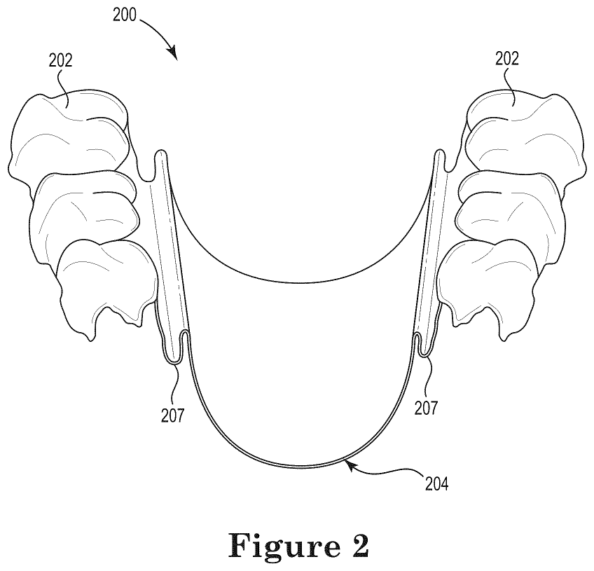

The figures herein follow a numbering convention in which the first digit or digits correspond to the drawing figure number and the remaining digits identify an element or component in the drawing. Similar elements or components between different figures may be identified by the use of similar digits. For example, 104 may reference element “04” in FIG. 1, and a similar element may be referenced as 204 in FIG. 2. As will be appreciated, elements shown in the various embodiments herein can be added, exchanged, and/or eliminated so as to provide a number of additional embodiments of the present disclosure. In addition, as will be appreciated, the proportion and the relative scale of the elements provided in the figures are intended to illustrate certain embodiments of the present invention, and should not be taken in a limiting sense.

FIG. 1 illustrates an example of a removable arch adjustment appliance having a transpalatal element that includes a number of flexing elements according to a number of embodiments of the present disclosure. The appliance 100, illustrated in the embodiment of FIG. 1, can include an upper dentition appliance (e.g., an appliance placed on the upper jaw of the patient). An upper jaw can include a maxilla and can include a number of teeth of a patient's upper dentition.

Appliances can include any positioners, retainers, and/or other removable dental appliances for finishing and maintaining teeth positioning in connection with a dental treatment. These appliances may be utilized by a treatment professional in performing a treatment plan. For example, a treatment plan can include the use of a set of appliances, created according to models described herein. Appliances, in some embodiments, can include flexible dental appliances which serve, in part, as a prosthesis for aesthetics and/or dental function.

An appliance can, for example, be fabricated from a polymeric shell, and/or formed from other material, having a cavity shaped to receive and apply force to reposition one or more teeth from one teeth arrangement to a successive teeth arrangement. The shell may be designed to fit over a number of, or in many instances all, teeth present in the upper jaw. The shell can include an interior surface (e.g., adjacent to a surface of the teeth place therein) and an exterior surface. The interior surface is configured to receive and apply forces to the teeth therein to reposition a number of teeth of the patient, for example.

In accordance with some embodiments of the present disclosure, the appliance 100 can include a removable shell 102 formed of a material and having a plurality of cavities formed therein. As discussed above, the plurality of cavities can be shaped to receive teeth of the patient, where the number of teeth include at least one molar on each side of the patient's jaw.

The appliance 100 can include an elastic transpalatal element 104 extending from the removable shell 102 in a lingual direction and across an arch width of the removable shell 102. The arch width of the removable shell 102, as used herein, is a space between the cavities of the removable shell 102. For instance, the transpalatal element 104 can expand across a surface of the mouth of the patient when the dental appliance 100 is placed over the teeth of the patient. The surface of the mouth can include, for instance, a palate and/or floor of the mouth.

The transpalatal element 104, as illustrated by FIG. 1, can be formed of a first material and can include a predetermined force characteristic. For example, the transpalatal element 104 can be formed such that transpalatal element 104 provides a certain force output that expands the space between the molars one each side of a patient's jaw or the palate of the patient. For instance, the force output can vary based the size of the space between the molars on each side of a patient's jaw or the palate of the patient, as well as the stage of the treatment plan, as will be further described herein.

As discussed above, the transpalatal element can be designed to expand an arch of teeth of the patient. For instance, the width of the transpalatal element 104 can be wider than the actual arch width of the teeth of the patient in order to define the desired arch width incremental target for the teeth. An arch width of the teeth of the patient can include a distance between teeth of the left posterior side of the patient's dentition and teeth of the right posterior side of the patient's dentition (e.g., a space between the posterior teeth, such as the molars and/or pre-molars, on each side of a patient's jaw or palate). As an example, the transpalatal element 104 can be 0.25 millimeters wider than the arch width of the teeth of the patient.

In some embodiments, the transpalatal element, or a portion thereof, can be made from a second material that can be different in at least one material property (e.g., chemical property of a material, weight of material used, mixture of chemicals used, etc.) than the first material. For instance, the rigidity of the second material can apply a force to at least a portion of the number of teeth in a transverse direction (e.g., horizontal direction) to expand the arch of teeth of the patient.

In some embodiments, the first material of the transpalatal element can form a first layer and the second material of the transpalatal element can form a second layer. The first layer of the first material can be formed integrally with and of a same material as the removable shell 102, for instance. The second layer of the second material can be formed in a separate process and attached to the first layer of the first material, for example.

In some embodiments, the transpalatal element can follow contours of a surface of the mouth of the patient when the appliance 100 is placed over the teeth of the patient. For example, the transpalatal element can be shaped to substantially follow the contours of the palate of the patient. This can be accomplished, for example, by taking a mold or scan of the surface of the palate of the patient and then forming the surface of the transpalatal element to substantially match (i.e., the surface may not be identical, as the transpalatal element may be designed to be wider as discussed above and therefore is not an identical copy of the mold/scan surface, and therefore may substantially match, but not be identical) the mold/scan surface using the physical data of the palate (e.g., the space between the molars on each side of the patient's jaw or the palate of the patient), where the physical data is obtained by the mold or the scan of the patient.

The contours of the palate in the appliance may be interpolated in anticipation of a stretching of the tissues during the expansion, in order to better accommodate the seating of the appliance in the patient's mouth. In other words, the shape of the appliance is designed to include an expected stretching of the patient's palatal lingual tissues during dental expansion, and not just a movement of the teeth.

The appliance 100 can be used for repositioning the number of teeth of the patient concurrently with expansion of the arch of teeth of the patient utilizing the transpalatal element. The expansion of the arch of teeth can include movement of posterior teeth (e.g., molars) and/or other teeth of the arch of the patient in a transverse direction and/or stretching of the maxillary suture of the patient (e.g., separates the maxillary halves in the region of the suture), along with a stretching of the surrounding soft tissues (e.g., the palatal gingiva) during the expansion.

The simultaneous treatment of misalignment of a patient's dental arch (e.g., insufficient dental arch width) in conjunction with teeth alignment issues (e.g., rotation, tipping, etc.) can, for example, potentially eliminate a second phase of a two phase treatment protocol, make the second phase less complex or a little more comfortable for the patient, shorten treatment times when compared to linear two-phase treatment protocols that first treat the misalignment of a patient's dental arch followed by treatment of misalignment of the patient's teeth. That is, the transpalatal element can, in accordance with a number of embodiments, avoid and/or not interfere with engagement of the removable shell 102 with the teeth therein and thereby allow for correction of various tooth misalignment issues during the arch expansion process. Therefore, the appliance can reposition the teeth of the patient concurrently as the transpalatal element expands at least one of the spaces between the molars on each side of a patient's jaw or palate so that both arch expansion and alignment correction occurs in tandem rather than as separate phases.

The transpalatal element 104 can include a number of force control elements to control the force provided by the transpalatal element 104 that expands the at least one molar on each side of the patient's jaw or the palate of the patient. As used herein, force control elements can control the force provided by the transpalatal element 104 as the patient's jaw and/or the palate of the patient expand. For example, force control elements can allow transpalatal element 104 to provide more or less expansion force as the patient's jaw and/or the palate of the patient is expanded.

The expansion force provided by the appliance 100 can be defined by Equation 1:

$$k = \frac{3 EI}{{l}^{3}} \qquad ( Eq . 1 )$$

where k is the spring constant of the first and/or second material, E is the modulus of elasticity of the first and/or second material, l is the length of the member, and I is a material constant (e.g., the second moment of area of the appliance).

The number of force control elements of the transpalatal element 104 can provide a non-linear force that expands the space between the molars on each side of a patient's jaw or the palate of the patient. In some embodiments, the number of force control elements of the transpalatal element 104 can provide a force that increases (e.g., exponentially) as the space between the molars on each side of the patient's jaw or the palate of the patient increases. In some embodiments, the number of force control elements of the transpalatal element 104 can provide a force that decreases (e.g., exponentially) as the space between the molars on each side of the patient's jaw or the palate of the patient increases. The force can increase and/or decrease until a specified distance, can increase exponentially and/or linearly, and/or decrease to zero.

The number of force control elements can include a number of flexing elements 106 in the transpalatal element 104 of the shell 102. The number of flexing elements 106 can control the force provided by the transpalatal element 104. For instance, the number of flexing elements 106 can control the force provided by the transpalatal element 104 such that the force provided by the transpalatal element 104 increases or decreases as the space between the molars on each side of the patient's jaw or the palate of the patient increases.

As shown in FIG. 1, the number of flexing elements 106 can include four flexing elements to control the force provided by the transpalatal element 104 of the shell 102. The four flexing elements 106 can be located substantially near an apex of the transpalatal element 104. The four flexing elements 106 can extend in a direction towards the tongue of the patient.

Flexing elements 106 can provide different non-linear force characteristics based on different design parameters. For instance, the non-linear force characteristics of the flexing elements 106 can be represented by Equation 1 above. The spring constant of appliance 100, as represented by Equation 1, may be influenced by design parameters including the number of flexing elements, length of the flexing elements (e.g., a distance the flexing element extends towards the tongue of the patient), the thickness of the flexing element, a distance between each flexing element, a bending curvature of each flexing element (e.g., a curvature of the length of the flexing element), and a bending/folding radius connecting adjacent flexing elements. Thus, the spring constant of each flexing element of an appliance, and consequently of an appliance itself, can vary non-linearly with length and thickness. Further, the curvature (e.g., the bending/folding radius) of segments connecting each flexing element may determine an extent of each flexing element bend until it settles on the adjacent element.

In some examples, a greater number of flexing elements may provide more non-linear force than a lesser number of flexing elements. In some examples, a first fold with a radius greater than a radius of a second fold may provide more non-linear force than the second fold. In some examples, a first fold with a length greater than the length of a second fold may provide more non-linear force than the second fold. In some examples, a greater distance between each fold of the number of flexing elements may provide more non-linear force than a smaller distance between each fold. The four flexing elements can control the force provided by the transpalatal element 104 of the shell 102. For example, the four flexing elements can provide a force that exponentially increases as the space between the molars on each side of the patient's jaw or the palate of the patient increases. In some embodiments, the four flexing elements can provide a force that exponentially decreases as the space between the molars on each side of the patient's jaw or the palate of the patient increases (e.g., as the transpalatal element 104 expands and the number of flexing elements are activated and flatten out).

Although the number of flexing elements 106 are shown in FIG. 1 as being the same length, embodiments of the present disclosure are not so limited. In some examples, the four flexing elements 106 can be longer or shorter. In some examples, two of the four flexing elements can be longer or shorter than the other two flexing elements.

Although the four flexing elements are shown in FIG. 1 and described as extending towards the tongue of the patient, embodiments of the present disclosure are not so limited. For example, the four flexing elements 106 can be bent towards the surface of the transpalatal element 104 such that they lie closer to and in a more substantially parallel fashion next to the surface of the transpalatal element 104.

The number of flexing elements 106 can be activated in different steps of expansion of the transpalatal element 104 of the shell. For example, as the expansion of the force providing portion 104 of the shell occurs, the two respective flexing elements located nearest the respective buccal sides of the patient's mouth may be activated to provide more or less expansion force as the space between the molars on each side of the patient's jaw or the palate of the patient increases. The two remaining flexing elements may be activated following activation of the two previous flexing elements. The two remaining flexing elements may be activated during expansion of the first two flexing elements, or after expansion of the first two flexing elements is finished.

Although not shown in FIG. 1 for clarity and so as not to obscure embodiments of the present disclosure, appliance 100 can include an expansion limiter. An expansion limiter can include a ball joint, a universal joint, an arm, mesh, a spring, and/or a hinge, although embodiments of the present disclosure are not limited to the above listed expansion limiters. The expansion limiter can direct the force output of appliance 100.

In some embodiments of the present disclosure, the appliance 100 can be a portion of a treatment plan. For instance, the treatment plan can include a series of appliances designed to incrementally implement a treatment plan. Each of the series of appliances can be a stage of the incremental treatment plan, for instance. The series can be used to reposition the teeth of the patient concurrently as the transpalatal element expands at least one of the spaces between the molars on each side of a patient's jaw or palate.

For instance, a first appliance, of a series of appliances designed to incrementally implement a treatment plan can comprise a first shell formed of a first material having a plurality of cavities therein designed to receive teeth of a jaw. The first appliance can include a first transpalatal element formed of a first layer of the first material and a second layer of the second material different than the first material.

The first transpalatal element can extend from the first shell across an arch width of the first shell. For instance, the first transpalatal element can have a first width specific to a first stage of the treatment plan and/or can be designed to expand at least one of the spaces between the molars on each side of a patient's jaw or the palate of the patient. The transpalatal element of the first appliance can provide force to expand the at least one of the space between the molars on each side of the patient's jaw or the palate of the patient by a predefined expansion length according to the first stage of the treatment plan. The predefined expansion length can be based on a stage of the treatment plan.

A second appliance, of the series of appliances, can comprise a second shell having a plurality of cavities therein designed to receive teeth of the jaw. The second appliance can include a second transpalatal element. For example, the second transpalatal element can have a second width specific to a second stage of the treatment plan. In some examples, the predefined expansion length of the transpalatal element of the second appliance can be different than the predefined expansion length of the transpalatal element of the first shell (e.g., can be more or less). In some examples, the predefined expansion length of the transpalatal element of the second appliance can be the same as the predefined expansion length of the transpalatal element of the first shell.

The second width can be wider than the first width. For instance, the second width can include an incremental increase in width as compared to the first width. The successive incremental increase in the arch width of the appliances can correspond to the desired gradual increase in at least one of the space between the molars on each side of a patient's jaw or the palate of the patient. For instance, the transpalatal element of the second appliance can provide force to expand the at least one of the space between the molars on each side of the patient's jaw or the palate of the patient by a predefined expansion length according to the second stage of the treatment plan.

A shape of the transpalatal elements of the shells and/or the shape of the force control elements can be specific to stages of the treatment plan. For example, the force control elements and/or the force providing portion of a first appliance specific to a first stage of a treatment plan may be shaped to provide more force than force control elements and/or the force providing portion of a second appliance specific to a second stage of the treatment plan.

Although the present embodiments illustrate two stages of a treatment plan, embodiments in accordance with the present disclosure are not so limited. Treatment plans can include a variety of number of stages, including more or less than two treatment stages. At least a portion of the stages can include treatment for gradual expansion of an arch of teeth of a patient. Alternatively and/or in addition, one or more of the stages may not include transpalatal elements, in various embodiments.

In an example embodiment, a system can include: a first appliance, of a series of appliances designed to incrementally implement a treatment plan, can include a removable shell having a plurality of cavities formed therein and shaped to receive teeth of a patient and wherein the teeth include at least one molar on each side of a patient's jaw, wherein the shell includes an elastic transpalatal element with a predetermined force characteristic that spans a palate of the patient and provides force to expand at least one of a space between the molars on each side of a patient's jaw or the palate of the patient, and wherein the transpalatal element includes a number of force control elements to control the force provided by the transpalatal element that expands the at least one of the space between the molars on each side of a patient's jaw or the palate of the patient. A second appliance, of the series of appliances, can including a removable shell having a plurality of cavities formed therein and shaped to receive teeth of a patient, wherein the shell includes an elastic transpalatal element with a predetermined force characteristic that spans a palate of the patient and provides force to expand at least one of the space between the molars on each side of a patient's jaw or the palate of the patient, and wherein the transpalatal element includes a number of force control elements to control the force provided by the transpalatal element that expands the at least one of the space between the molars on each side of a patient's jaw or the palate of the patient.

In some embodiments, a virtual appliance including a transpalatal element can be formed of a material using a virtual model of a palate of a patient and a virtual model of a number of teeth of the patient. The transpalatal element can be wider than an arch width of the number of teeth of the first jaw of the patient, specific to a stage of a treatment plan, and can be shaped to substantially follow contours of the palate of the patient (that may also include modeling of anticipated changes to the palatal contours due to tissue stretching), for instance.

The palatal contours in the model can also be specifically raised in a vertical direction so that any appliance which is formed over the model is slightly raised in comparison to the actual contours of the palate. In other words, a slight gap between the actual palate and the palatal coverage portion of the appliance can be designed to be present. This gap allows the transverse benefits of the appliance design to be in effect while not necessarily requiring an exact fit of the appliance to the contours of the tissue.

A slight offset in the vertical dimension can minimize any disruption in speech, swallowing, or feel due to changes in tongue position that may result in the alteration. More importantly, intentionally raising the vertical dimension of only the palatal tissue regions has the benefit of not needing perfect modeling of any non-linear stretching that might take place in the tissue. This can greatly reduce the risk of uncomfortable pressure spots and sores caused by the appliance. Having to relieve pressure spots in the appliance can be very time consuming for the treatment professional, and if the appliance is thin to begin with, such adjustments can lead to weakened areas in the appliance.

A virtual model of a number of teeth of the patient can, for example, include an initial virtual dental model and/or an intermediate virtual dental model. A virtual model of the palate (and/or other tissue surfaces of the patient's mouth) can include the contours of the palate. In some embodiments, the virtual model of the palate and the virtual model of the number of teeth can include a single virtual model and/or two separate virtual models.

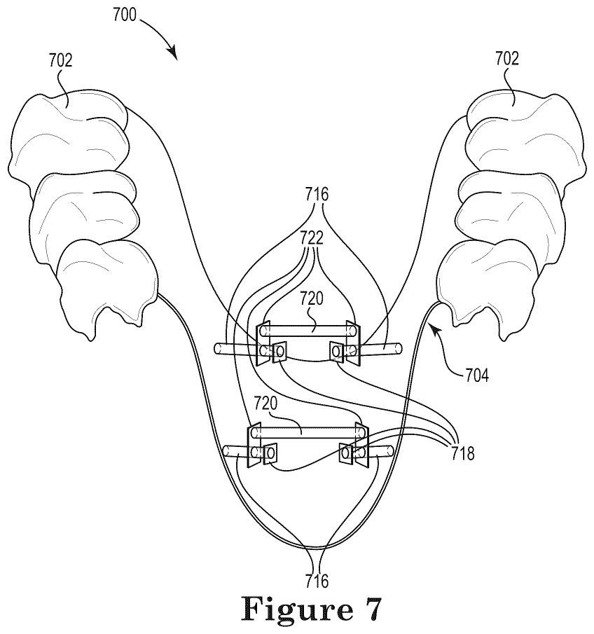

The transpalatal element and/or stop mechanisms (e.g., as will be further described in connection with FIGS. 7-13) can be formed by a rapid prototyping process, such as, for example, by a Computer-aided manufacturing (CAM) milling, stereolithography, 3D printing, fused deposition modeling (FDM), selective laser sintering (SLS), and/or photolithography. Advantages of such techniques can include, for example, that multiple materials can be used in a single build, various cross sectional thickness's can be designed and built for rigidity, and easy fabrication of a complex organic geometry.

In some embodiments, the flexibility of the appliance is such that it can be compressed in the transverse direction during seating in order to activate the expansion force. This force then gets released and directed towards the teeth, soft tissues, and/or jaw bone when then the appliance is seated in the mouth.

As discussed above, in some embodiments, the transpalatal element can be shaped to substantially follow contours of the palate of the patient using the virtual model of the palate. Alternatively and/or in addition, the transpalatal element can be shaped to substantially follow contours of the floor of the mouth of the patient using a virtual model of the floor of the mouth.

To form an appliance, a removable shell can, for example, be formed over a set of molded teeth. The removable shell can include a plurality of cavities formed therein, wherein the plurality of cavities are shaped to receive the number of teeth of the patient. In various embodiments, the removable shell can include a second portion of the transpalatal element formed of the same material as the plurality of cavities. The second portion of the transpalatal element can be formed integrally with and/or during a same process as the plurality of cavities, for instance.

The material forming the first portion of the transpalatal element can be more rigid than the material forming the second portion of the transpalatal element, for instance. In some embodiments, the second portion of the transpalatal element can include the same width as the first portion of the transpalatal element.

Alternatively and/or in addition, the first portion of the transpalatal element can be designed to be adjacent to and/or in contact with a surface of the patient's mouth (e.g., the palate and/or floor of the patient's mouth) when the dental appliance is placed over the teeth of the patient. The second portion of the transpalatal element can be designed to be adjacent to and/or in contact with a tongue of the patient when the dental appliance is placed over the teeth of the patient.

The dental appliance can be made, for example, by thermoforming a piece of plastic over a physical dental model. The physical dental model, for instance, can represent an incremental position to which a patient's teeth are to be moved. This desired position of the patient's teeth includes any underlying desired changes to the skeletal structure which holds the teeth in place.

In some embodiments, a treatment file can be accessed by a rapid prototyping apparatus machine, such as a SLA or printing, to form and/or create the dental model. The result of the dental model can include a set of molded teeth (e.g., a physical set of molded teeth). The set of molded teeth can include at least a replica of a number of teeth of the patient. The dental model can be used to make a dental appliance, for example, by creating a negative impression of the dental model using polymeric sheets of material and vacuum forming heated sheets of the polymer over the dental model, as discussed above.

For instance, a dental appliance can be created by layering a thermoformable sheet of material and/or multiple sheets of one or more materials over the dental model. The materials can include at least one polymeric material, for instance.

Generally, the dental appliance can be produced and/or formed, for example, by heating the polymeric thermoformable sheet and vacuum or pressure forming the sheet over the dental model (i.e.., over a number of the teeth in the mold). The shape of the sheet of material can be designed to intentionally vary in thickness in some portions of the sheet (beyond natural variations in thickness during the shaping process) as it conforms to the mold shape. A dental appliance can, for example, include a negative impression of the dental model. The appliance and/or parts thereof may be transparent, semi-transparent, or opaque in such a way as to emulate a natural tooth shade.

Force control elements of an arch adjustment appliance can eliminate the need for a patient to utilize screws and/or other mechanisms to incrementally activate expansion. Force control elements can allow for more precise forces to be applied to expand the space between the molars on each side of a patient's jaw or the palate of the patient, which may shorten the length of a treatment plan and avoid discomfort and/or pain for the patient. Additionally, the arch adjustment appliances can be more aesthetically pleasing.

FIG. 2 illustrates an example of a removable arch adjustment appliance having a transpalatal element that includes a number of flexing elements according to the present disclosure. As illustrated by the embodiment of FIG. 2, the appliance 200 can include a removable shell 202, a transpalatal element 204, and a number of flexing elements 207.

As previously described in connection with FIG. 1, the removable shell 202 can include a plurality of cavities formed therein, wherein the plurality of cavities are shaped to receive the number of teeth of the patient. The removable shell 202, as illustrated in FIG. 2, can include a virtual removable shell, a physical removable shell, and/or material to be thermoformed over a dental model.

Additionally, as previously described in connection with FIG. 1, the transpalatal element 204 can include a number of force control elements to control the force provided by the force expansion providing portion 204. The number of force control elements can include a number of flexing elements 207 that can be activated in different steps of expansion of the transpalatal element 204 of the shell 202.

As shown in FIG. 2, the number of flexing elements 207 can include two flexing elements to control the force provided by the transpalatal element 204 of the shell 202. The two flexing elements can be located substantially near the removable shell 202. The two flexing elements can extend in a direction towards the palate of the patient.

The number of flexing elements 207 can provide different non-linear force characteristics based on different design parameters. In some examples, a greater number of flexing elements may provide more non-linear force than a lesser number of flexing elements. In some examples, a first flexing element with a radius greater than a radius of a second flexing element may provide more non-linear force than the second flexing element. In some examples, a first flexing element with a length greater than the length of a second flexing element may provide more non-linear force than the second flexing element. In some examples, a greater distance between each flexing element of the number of flexing elements may provide more non-linear force than a smaller distance between each flexing element.

The two flexing elements can control the force provided by the transpalatal element 204 of the shell 202. For example, the two flexing elements can provide a force that exponentially increases as the space between the molars on each side of the patient's jaw or the palate of the patient increases. In some embodiments, the two flexing elements can provide a force that exponentially decreases as the space between the molars on each side of the patient's jaw or the palate of the patient increases.

Although the two flexing elements are shown in FIG. 1 and described as extending towards the palate of the patient, embodiments of the present disclosure are not so limited. For example, the two flexing elements can be bent towards the surface of the transpalatal element 204 such that they lie closer to and in a more substantially parallel fashion next to the surface of the transpalatal element 204.

Although the number of flexing elements 207 are shown in FIG. 2 as being the same length, embodiments of the present disclosure are not so limited. In some examples, the two flexing elements 207 can be longer or shorter. In some examples, one of the two flexing elements 207 can be longer or shorter than the second of the two flexing elements 207.

Although not shown in FIG. 2 for clarity and so as not to obscure embodiments of the present disclosure, appliance 200 can include an expansion limiter. An expansion limiter can include a ball joint, a universal joint, an arm, mesh, a spring, and/or a hinge, although embodiments of the present disclosure are not limited to the above listed expansion limiters. The expansion limiter can direct the force output of appliance 200.

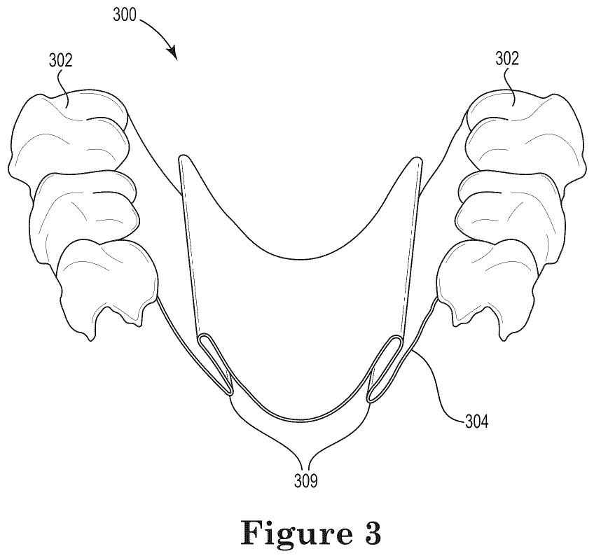

FIG. 3 illustrates an example of a removable arch adjustment appliance having a transpalatal element that includes a number of flexing elements according to a number of embodiments of the present disclosure. As illustrated by the embodiment of FIG. 3, the appliance 300 can include a removable shell 302, a transpalatal element 304, and a number of flexing elements 309.

As previously described in connection with FIG. 1, the removable shell 302 can include a plurality of cavities formed therein, wherein the plurality of cavities are shaped to receive the number of teeth of the patient. The removable shell 302, as illustrated in FIG. 3, can include a virtual removable shell, a physical removable shell, and/or material to be thermoformed over a dental model.

Additionally, as previously described in connection with FIG. 1, the transpalatal element 304 can include a number of force control elements to control the force provided by the force expansion providing portion 304. The number of force control elements can include a number of flexing elements 309 that can be activated in different steps of expansion of the transpalatal element 304 of the shell 302.

As shown in FIG. 3, the number of flexing elements 309 can include two flexing elements to control the force provided by the transpalatal element 304 of the shell 302. The two flexing elements can be located substantially between an apex of the transpalatal element 304 of the shell 302 and the plurality of cavities of the shell 302. The two flexing elements can extend in a direction towards the palate of the patient.

The number of flexing elements 309 can provide different non-linear force characteristics based on different design parameters. In some examples, a greater number of flexing elements may provide more non-linear force than a lesser number of flexing elements. In some examples, a first flexing element with a radius greater than a radius of a second flexing element may provide more non-linear force than the second flexing element. In some examples, a first flexing element with a length greater than the length of a second flexing element may provide more non-linear force than the second flexing element. In some examples, a greater distance between each flexing element of the number of flexing elements may provide more non-linear force than a smaller distance between each flexing element.

The two flexing elements can control the force provided by the transpalatal element 304 of the shell 302. For example, the two flexing elements can provide a force that exponentially increases as the space between the molars on each side of the patient's jaw or the palate of the patient increases. In some embodiments, the two flexing elements can provide a force that exponentially decreases as the space between the molars on each side of the patient's jaw or the palate of the patient increases.

Although the number of flexing elements 309 are shown in FIG. 3 as being the same length, embodiments of the present disclosure are not so limited. In some examples, the two flexing elements 309 can be longer or shorter. In some examples, one of the two flexing elements 309 can be longer or shorter than the second of the two flexing elements 309.

Although not shown in FIG. 3 for clarity and so as not to obscure embodiments of the present disclosure, appliance 300 can include an expansion limiter. An expansion limiter can include a ball joint, a universal joint, an arm, mesh, a spring, and/or a hinge, although embodiments of the present disclosure are not limited to the above listed expansion limiters. The expansion limiter can direct the force output of appliance 300.

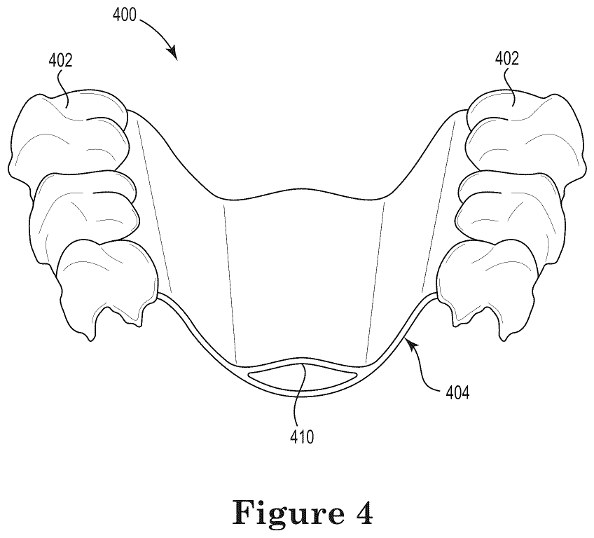

FIG. 4 illustrates an example of a removable arch adjustment appliance having a transpalatal element that includes a member according to one or more embodiments of the present disclosure. As illustrated by the embodiment of FIG. 4, the appliance 400 can include a removable shell 402, a transpalatal element 404, and a member that is a cross member 410.

As previously described in connection with FIG. 1, the removable shell 402 can include a plurality of cavities formed therein, wherein the plurality of cavities are shaped to receive the number of teeth of the patient. The removable shell 402, as illustrated in FIG. 4, can include a virtual removable shell, a physical removable shell, and/or material to be thermoformed over a dental model.

Additionally, as previously described in connection with FIG. 1, the transpalatal element 404 can include a number of force control elements to control the force provided by the force expansion providing portion 404. The number of force control elements can include a cross member 410.

The cross member 410 can control the force provided by the transpalatal element 404 of the shell 402. For example, the cross member 410 can provide a force that exponentially increases as the space between the molars on each side of the patient's jaw or the palate of the patient increases. In some embodiments, the cross member 410 can provide a force that exponentially decreases as the space between the molars on each side of the patient's jaw or the palate of the patient increases.

Cross member 410 can provide different non-linear force characteristics based on a size of the cross member and/or a material of the cross member. In some examples, a larger cross-sectional area of the cross member can generate more force, and a smaller cross-sectional area of the cross member can generate less force. In some examples, a cross member made of a first material can generate more force than a cross member made of a second material.

In some embodiments, the cross member 410 can act as a stop mechanism. In some examples, the cross member 410 can be attached to the transpalatal element 404 such that the cross member 410 includes a loaded force. In some examples, the cross member 410 can be attached to the transpalatal element 404 such that the cross member 410 does not include a loaded force, but a loaded force is induced when the cavities of the removable shell 402 receive the teeth of the patient (e.g., appliance 400 is placed in the patient's mouth). In either example, expansion of the space between the molars on each side of a patient's jaw or the palate of the patient can cause the loaded force of cross member 410 to be removed. Once the loaded force of cross member 410 is removed, the expansion force of the transpalatal element 404 goes to zero as the cross member 410 prevents the transpalatal element 404 from further expansion.

In some embodiments, the cross member 410 can be of the same material as the shell 402. In some embodiments, the cross member 410 can be of the same material as the transpalatal element 404.

Although not shown in FIG. 4 for clarity and so as not to obscure embodiments of the present disclosure, appliance 400 can include an expansion limiter. An expansion limiter can include a ball joint, a universal joint, an arm, mesh, a spring, and/or a hinge, although embodiments of the present disclosure are not limited to the above listed expansion limiters. The expansion limiter can direct the force output of appliance 400.

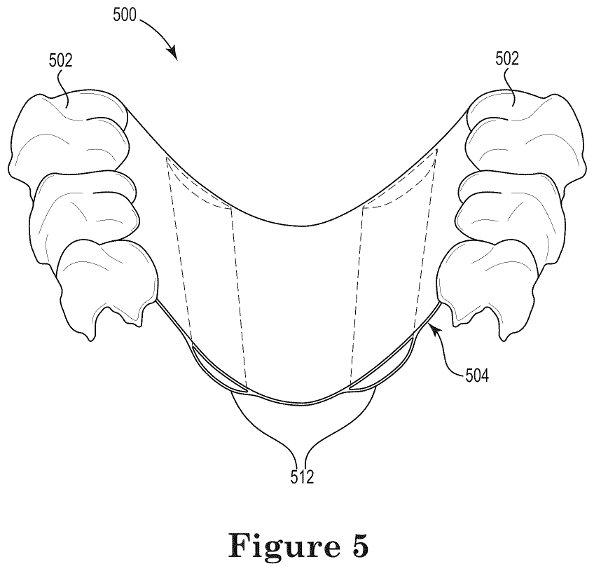

FIG. 5 illustrates an example of a removable arch adjustment appliance having a transpalatal element that includes two members attached thereto according to one or more embodiments of the present disclosure. As illustrated by the embodiment of FIG. 5, the appliance 500 can include a removable shell 502, a transpalatal element 504, and two members 512.

As previously described in connection with FIG. 1, the removable shell 502 can include a plurality of cavities formed therein, wherein the plurality of cavities are shaped to receive the number of teeth of the patient. The removable shell 502, as illustrated in FIG. 5, can include a virtual removable shell, a physical removable shell, and/or material to be thermoformed over a dental model.

Additionally, as previously described in connection with FIG. 1, the transpalatal element 504 can include a number of force control elements to control the force provided by the force expansion providing portion 504. The number of force control elements can include two members 512 attached to the side of the transpalatal element 504 of the shell 502 that face the palate of the patient.

The two members 512 can control the force provided by the transpalatal element 504 of the shell 502. For example, the two members 512 can provide a force that exponentially increases as the space between the molars on each side of the patient's jaw or the palate of the patient increases. In some embodiments, the two members 512 can provide a force that exponentially decreases as the space between the molars on each side of the patient's jaw or the palate of the patient increases.

The two members 512 can provide different non-linear force characteristics based on a size of the two members and/or a material of the two members. In some examples, a larger cross-sectional area of the two members can generate more force, and a smaller cross-sectional area the two members can generate less force. In some examples, the members made of a first material can generate more force than two members made of a second material.

In some embodiments, the two members 512 can be of the same material as the shell 502. In some embodiments, the two members 512 can be of the same material as the transpalatal element 504. In some embodiments, one of the two members 512 can be of a different material than the other of the two members 512.

Although not shown in FIG. 5 for clarity and so as not to obscure embodiments of the present disclosure, appliance 500 can include an expansion limiter. An expansion limiter can include a ball joint, a universal joint, an arm, mesh, a spring, and/or a hinge, although embodiments of the present disclosure are not limited to the above listed expansion limiters. The expansion limiter can direct the force output of appliance 500.

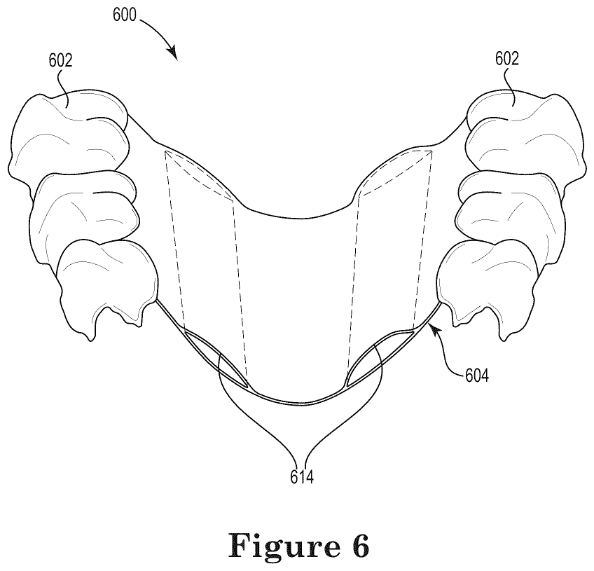

FIG. 6 illustrates an example of a removable arch adjustment appliance having a transpalatal element that includes two members attached thereto according to one or more embodiments of the present disclosure. As illustrated by the embodiment of FIG. 6, the appliance 600 can include a removable shell 602, a transpalatal element 604, and two members 614.

As previously described in connection with FIG. 1, the removable shell 602 can include a plurality of cavities formed therein, wherein the plurality of cavities are shaped to receive the number of teeth of the patient. The removable shell 602, as illustrated in FIG. 6, can include a virtual removable shell, a physical removable shell, and/or material to be thermoformed over a dental model.

Additionally, as previously described in connection with FIG. 1, the transpalatal element 604 can include a number of force control elements to control the force provided by the force expansion providing portion 604. The number of force control elements can include two members 614 attached to the side of the transpalatal element 604 of the shell 602 that face the tongue of the patient.

The two members 614 can control the force provided by the transpalatal element 604 of the shell 602. For example, the two members 614 can provide a force that exponentially increases as the space between the molars on each side of the patient's jaw or the palate of the patient increases. In some embodiments, the two members 614 can provide a force that exponentially decreases as the space between the molars on each side of the patient's jaw or the palate of the patient increases.

The two members 614 can provide different non-linear force characteristics based on a size of the two members and/or a material of the two members. In some examples, a larger cross-sectional area of the two members can generate more force, and a smaller cross-sectional area the two members can generate less force. In some examples, the members made of a first material can generate more force than two members made of a second material.

In some embodiments, the two members 614 can be of the same material as the shell 602. In some embodiments, the two members 614 can be of the same material as the transpalatal element 604. In some embodiments, one of the two members 614 can be of a different material than the other of the two members 614.

Embodiments of the present disclosure can also provide other beneficial functions. For example, embodiments can maintain space in the patient's mouth when the patient's primary and permanent dentition have a size discrepancy.

For instance, unlike the anterior teeth, the permanent premolars may be smaller than the primary teeth they replace. On average, the mandibular primary second molar is 2 mm larger than the second premolar and, in the maxillary arch, the primary second molar is only 1.5 mm larger. The primary first molar is only 0.5 mm larger than the first premolar. Accordingly, on average, this results in 2.5 mm of space, called leeway space, in the mandibular arch and 1.5 mm in the maxillary arch. The leeway space is usually taken by mesial movement of the permanent molars (the permanent first molars move mesially relatively rapidly).

This creates an opportunity to gain arch length and relieve crowding by stopping the first molar mesial movement by, for example, using a pontic along with the appliance by filling the appliance tooth space and leaving clearance for an erupting tooth. The filled pontic material can be used to keep the first molar from moving into the leeway space while allowing the permanent premolar to erupt.

It should be noted that in some embodiments, portions of the appliance may not be visible to people when they see the appliance in the patient's mouth and as such the material does not have to be clear, and this therefore allows for more options with regard to the choice of material that can be utilized. With some manufacturing processes, as discussed herein, the appliance can be fabricated from multiple materials or can be manufactured in parts wherein the parts are made from different materials and are attached together to create the appliance.

Although not shown in FIG. 6 for clarity and so as not to obscure embodiments of the present disclosure, appliance 600 can include an expansion limiter. An expansion limiter can include a ball joint, a universal joint, an arm, mesh, a spring, and/or a hinge, although embodiments of the present disclosure are not limited to the above listed expansion limiters. The expansion limiter can direct the force output of appliance 600.

FIG. 7 illustrates an example of a removable arch adjustment appliance having a transpalatal element that includes a sliding stop mechanism according to a number of embodiments of the present disclosure. As illustrated by the embodiment of FIG. 7, the appliance 700 can include a removable shell 702, a transpalatal element 704, two opposing members 716, tabs of the two opposing members 718, connection member 720, and tabs of the connection member 722.

The appliance 700 shown in FIG. 7 can be similar to the appliance previously described in connection to FIG. 1. For example, appliance 700 can include a removable shell 702 having a plurality of cavities formed therein, wherein the plurality of cavities are shaped to receive teeth of a patient and wherein the teeth include at least one molar on each side of a patient's jaw, and wherein the shell 702 includes an elastic transpalatal element 704 with a predetermined force characteristic that spans a palate of the patient, wherein the transpalatal element 704 provides force to expand at least one of the space between the molars on each side of a patient's jaw or the palate of the patient.

Appliance 700 can include a stop mechanism located on shell 702 that provides a mechanical force on the transpalatal element 704 of the shell 702 at a predefined expansion length of the transpalatal element 704. As used herein, a stop mechanism can provide a mechanical force on the transpalatal element 704 to reduce and/or prevent any further expansion of the space between the molars on each side of the patient's jaw and/or the palate of the patient after expansion of the space between the molars on each side of the patient's jaw and/or the palate of the patient by a predefined expansion length. That is, the mechanical force can reduce and/or counteract the force provided by the transpalatal element that expands the at least one of the space between the molars on each side of a patient's jaw or the palate of the patient.

The stop mechanism can be a sliding stop mechanism. As shown in FIG. 7, the sliding stop mechanism can include two opposing members 716 partially spanning, in a lingual direction, the transpalatal element 704 of the shell 702. Each of the opposing members 716 can include a tab 718, as will be further described herein.

The stop mechanism can include a connection member 720 connected to the two opposing members 716. The connection member 720 can include two tabs 722. The connection member 720 can be connected to the two opposing members 716 by way of the two tabs 722. For example, each of the two tabs 722 can include a hole large enough such that each of the two opposing members 716 may fit through each of the holes of the two tabs 722. This connection can allow for the two opposing members 716 and the connection member 720 to slide relative to each other during expansion of the appliance 700.

The two opposing members 716 and the connection member 720 can slide relative to each other during expansion of the appliance 700 until the predefined expansion length. That is, the two tabs 722 of the connection member 720 provide mechanical force on the transpalatal element 704 of the shell 702 by way of the two tabs 718 of the two opposing members 716 at the predefined expansion length that is equal to and opposite of the force provided by the transpalatal element 704 of the shell 702. In other words, the two tabs 722 stop expansion of the appliance 700 at the predefined expansion length, preventing the appliance 700 from over expanding the space between the molars on each side of the patient's jaw and/or the palate of the patient.

The components of the stop mechanism (e.g., two opposing members 716, tabs 718 of the two opposing members 716, connection member 720, and tabs 722 of the connection member 720) can be assembled by a one piece direct fabrication process. Alternatively, the components of the stop mechanism can be fabricated separately and then assembled.

The stop mechanisms can stop expansion of the appliance 700 at a predefined expansion length that can be based on a stage of a treatment plan. For example, a first appliance can include a first stop mechanism designed to stop expansion of the first appliance at a predefined expansion length based on a first stage of a treatment plan. A second appliance can include a second stop mechanism designed to stop expansion of the second appliance at a predefined expansion length based on a second stage of the treatment plan, where the predefined expansion lengths at each stage of the treatment plan can be different.

In an example embodiment, a system can include: a first appliance, of a series of appliances designed to incrementally implement a treatment plan, including a stop mechanism and a removable shell having a plurality of cavities formed therein and shaped to receive teeth of a patient and wherein the teeth include at least one molar on each side of a patient's jaw, wherein the shell includes an elastic transpalatal element with a predetermined force characteristic that spans a palate of the patient and provides force to expand at least one of a space between the molars on each side of a patient's jaw or the palate of the patient, and wherein the stop mechanism is located on the shell and provides a mechanical force on the transpalatal element of the shell of the first appliance at a predefined expansion length of the transpalatal element to reduce the force provided by the transpalatal element that expands the at least one of the space between the molars on each side of a patient's jaw or the palate of the patient. A second appliance, of the series of appliances, can include a stop mechanism and a removable shell having a plurality of cavities formed therein and shaped to receive teeth of a patient, wherein the shell includes an elastic transpalatal element with a predetermined force characteristic that spans a palate of the patient and provides force to expand at least one of the space between the molars on each side of a patient's jaw or the palate of the patient, and wherein the stop mechanism is located on the shell and provides a mechanical force on the transpalatal element of the shell of the first appliance at a predefined expansion length of the transpalatal element to reduce the force provided by the transpalatal element that expands the at least one of the space between the molars on each side of a patient's jaw or the palate of the patient.

Stop mechanisms of an arch adjustment appliance can help reduce the risk of over expansion of the space between the molars on each side of a patient's jaw or the palate of the patient. The reduced risk of over expansion can allow for different forces to be applied at stages of a treatment plan, which may shorten the length of a treatment plan and avoid discomfort and/or pain for the patient.

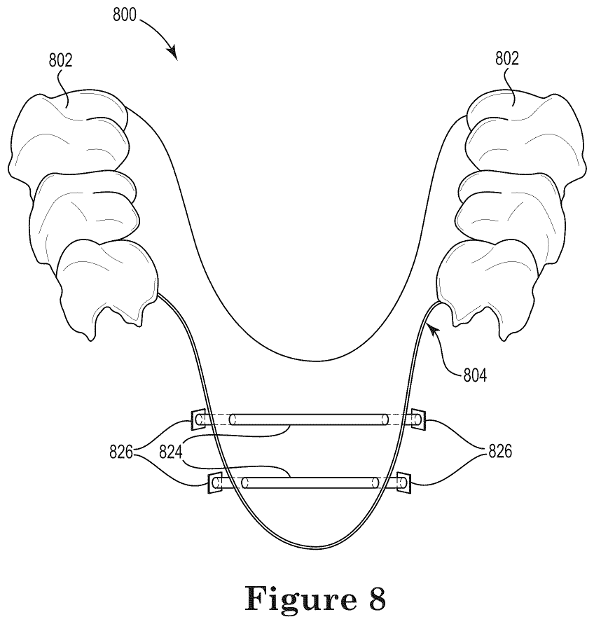

FIG. 8 illustrates an example of a removable arch adjustment appliance having a transpalatal element that includes a sliding stop mechanism according to a number of embodiments of the present disclosure. As illustrated by the embodiment of FIG. 8, the appliance 800 can include a removable shell 802, a transpalatal element 804, spanning member 824, and tabs 826 of the spanning member 824.

Similar to the appliance described in connection with FIG. 7, appliance 800 can include a stop mechanism. The stop mechanism can be a sliding stop mechanism. As shown in FIG. 8, the sliding stop mechanism can include a member 824 spanning, in a lingual direction, the transpalatal element 804 of the shell 802. The member 824 can include tabs 826 on opposing sides of the member 824.

The transpalatal element 804 can include holes large enough such that the spanning member 824 may fit through each of the holes of the transpalatal element 804. This connection can allow for the transpalatal element 804 to slide along/relative to the spanning member 824 during expansion of the appliance 800.

The transpalatal element 804 can slide along/relative to the spanning member 824 during expansion of the appliance 800 up until the predefined expansion length. That is, the two tabs 826 of the spanning member 824 provide mechanical force on the transpalatal element 804 of the shell 802 at the predefined expansion length that is equal to and opposite of the force provided by the transpalatal element 804 of the shell 802. In other words, the two tabs 826 stop expansion of the appliance 800 at the predefined expansion length, preventing the appliance 800 from over expanding the space between the molars on each side of the patient's jaw and/or the palate of the patient, where the predefined expansion length can be based on a stage of a treatment plan.

The components of the stop mechanism (e.g., spanning member 824 and tabs 826 of the spanning member 824) can be assembled by a one piece direct fabrication process. Alternatively, the components of the stop mechanism can be fabricated separately and then assembled.

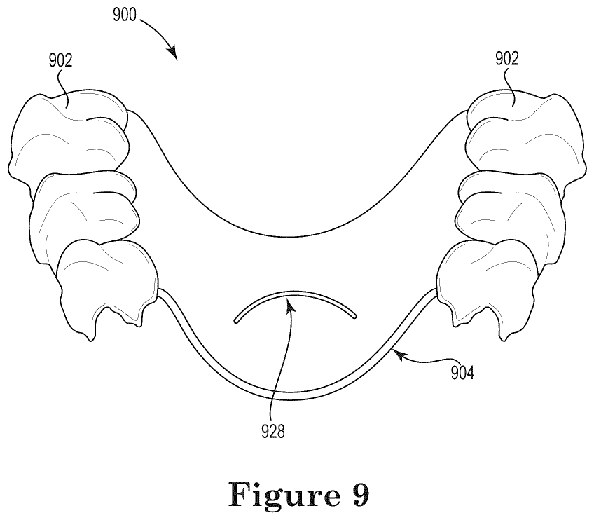

FIG. 9 illustrates an example of a removable arch adjustment appliance having a transpalatal element that includes a tension stop mechanism according to a number of embodiments of the present disclosure. As illustrated by the embodiment of FIG. 9, the appliance 900 can include a removable shell 902, a transpalatal element 904, and flexible member 928.

Appliance 900 can include a stop mechanism, such as a tension stop mechanism. As shown in FIG. 9, the tension stop mechanism can include a flexible member 928 that spans, in a lingual direction, the transpalatal element 904 of the shell 902. The flexible member 928 can be of different materials, such as fabric (e.g., a string), polymeric, metallic (e.g., a chain), etc.

The flexible member 928 can be slack when inserted into a patient's mouth for expansion of the space between the molars on each side of the patient's jaw and/or the palate of the patient. During expansion of the appliance 900, the flexible member 928 can become taut. That is, the flexible member 928 can provide mechanical force on the transpalatal element 904 of the shell 902 at the predefined expansion length that is equal to and opposite of the force provided by the transpalatal element 904 of the shell 902. In other words, the flexible member 928 stops expansion of the appliance 900 at the predefined expansion length, preventing the appliance 900 from over expanding the space between the molars on each side of the patient's jaw and/or the palate of the patient, where the predefined expansion length can be based on a stage of a treatment plan.

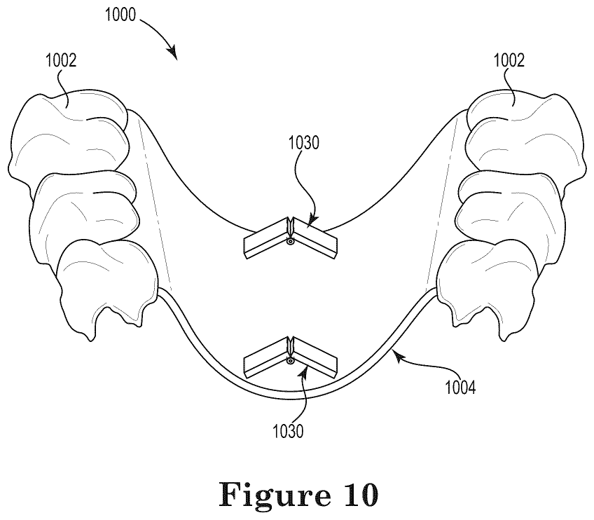

FIG. 10 illustrates an example of a removable arch adjustment appliance having a transpalatal element that includes a tension stop mechanism according to a number of embodiments of the present disclosure. As illustrated by the embodiment of FIG. 10, the appliance 1000 can include a removable shell 1002, a transpalatal element 1004, and one or more hinged members 1030.

Appliance 1000 can include a stop mechanism, such as a tension stop mechanism. As shown in FIG. 10, the tension stop mechanism can include one or more hinged members 1030 that spans, in a lingual direction, the transpalatal element 1004 of the shell 1002.

The one or more hinged members 1030 can be in a hinged orientation (e.g., not straight) when inserted into a patient's mouth for expansion of the space between the molars on each side of the patient's jaw and/or the palate of the patient. During expansion of the appliance 1000, the one or more hinged members 1030 can move to an unhinged orientation (e.g., is pulled upwards and straightens out) as the appliance 1000 expands. That is, the one or more hinged members 1030 can provide mechanical force on the transpalatal element 1004 of the shell 1002 at the predefined expansion length that is equal to and opposite of the force provided by the transpalatal element 1004 of the shell 1002. In other words, the one or more hinged members 1030 stop expansion of the appliance 1000 at the predefined expansion length, preventing the appliance 1000 from over expanding the space between the molars on each side of the patient's jaw and/or the palate of the patient, where the predefined expansion length can be based on a stage of a treatment plan.

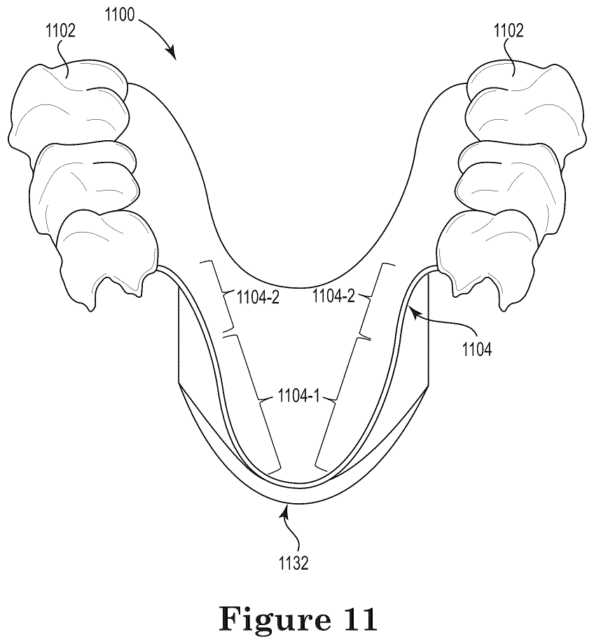

FIG. 11 illustrates an example of a removable arch adjustment appliance having a transpalatal element that includes a deflection limit stop mechanism according to a number of embodiments of the present disclosure. As illustrated by the embodiment of FIG. 11, the appliance 1100 can include a removable shell 1102, a transpalatal element 1104, first portion of transpalatal element 1104-1, second portion of transpalatal element 11-4-2, and curved stop mechanism 1132.

Appliance 1100 can include a stop mechanism, such as a deflection limit stop mechanism. As shown in FIG. 11, the deflection limit stop mechanism can include a curved stop mechanism 1132 with substantially the same shape as the transpalatal element 1104 of the shell 1102. The curved stop mechanism 1132 can be located at the apex of the transpalatal element 1104 and on the side of the transpalatal element 1104 facing the palate of the patient. The curved stop mechanism 1132 can be of the same material as the transpalatal element 1104, or of a different material.

Prior to expansion of the appliance 1100 (e.g., as shown in FIG. 11), the transpalatal element 1104 does not lie next to (e.g., adjacent to) the curved stop mechanism 1132. During expansion of the appliance 1100, a first portion 1104-1 of the transpalatal element 1104 can become adjacent to the curved stop mechanism 1132, while a second portion 1104-2 of the transpalatal element 1104 can continue to expand. That is, the curved stop mechanism 1132 can provide mechanical force on the first portion 1104-1 of the transpalatal element 1104 of the shell 1102 at the predefined expansion length that is equal to and opposite of the force provided by the first portion 1104-1 of the transpalatal element 1104 of the shell 1102, where the second portion 1104-2 of the transpalatal element 1104 is uninhibited by the curved stop mechanism 1132. In other words, the curved stop mechanism 1132 stops expansion of the first portion 1104-1 of the transpalatal element 1104, while the second portion 1104-2 of the transpalatal element 1104 can continue to expand. The curved stop mechanism 1132 can stop expansion of the first portion 1104-1 at a predefined expansion length based on a stage of a treatment plan.

Allowing the second portion 1104-2 to continue to expand once the curved stop mechanism 1132 has prevented the first portion 1104-1 from expanding can allow for different force characteristics for the transpalatal element 1104. For example, the force provided by the second portion 1104-2 may be higher as the appliance 1100 continues to expand, which may be beneficial based on a stage of a treatment plan.

The first portion 1104-1 and the second portion 1104-2 can be the same length, or can be different lengths. For example, the first portion 1104-1 can be longer than the second portion 1104-2, or, alternatively, the first portion 1104-1 can be shorter than the second portion 1104-2. The lengths of the first portion 1104-1 and the second portion 1104-2 can depend on the force characteristic needed for expansion of the space between the molars on each side of the patient's jaw and/or the palate of the patient, and/or can be based on a stage of a treatment plan.

Although not shown in FIG. 11 for clarity and so as not to obscure embodiments of the present disclosure, the stop mechanism 1132 can be substantially planar in a lingual direction. The stop mechanism 1132 can include two protruding members on opposite sides of the planar stop mechanism, where the two protruding members are normal to the planar stop mechanism.

Prior to expansion of the appliance, the transpalatal element 1104 does not contact either of the protruding members. During expansion of the appliance 1100, a first portion 1104-1 of the transpalatal element 1104 can come into contact with the protruding members, while a second portion 1104-2 of the transpalatal element 1104 can continue to expand. That is, the protruding members can provide mechanical force on the first portion 1104-1 of the transpalatal element 1104 of the shell 1102 at the predefined expansion length that is equal to and opposite of the force provided by the first portion 1104-1 of the transpalatal element 1104 of the shell 1102, where the second portion 1104-2 of the transpalatal element 1104 is uninhibited by the protruding members. In other words, the protruding members can stop expansion of the first portion 1104-1 of the transpalatal element 1104, while the second portion 1104-2 of the transpalatal element 1104 can continue to expand. The protruding members can stop expansion of the first portion 1104-1 at a predefined expansion length based on a stage of a treatment plan.

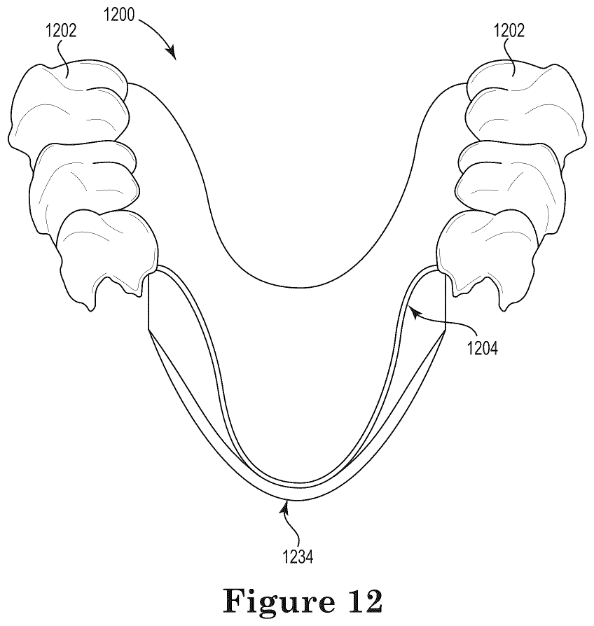

FIG. 12 illustrates an example of a removable arch adjustment appliance having a transpalatal element that includes a deflection limit stop mechanism according to a number of embodiments of the present disclosure. As illustrated by the embodiment of FIG. 12, the appliance 1200 can include a removable shell 1202, a transpalatal element 1204, and curved stop mechanism 1234.

Appliance 1200 can include a stop mechanism, such as a deflection limit stop mechanism. As shown in FIG. 12, the deflection limit stop mechanism can include a curved stop mechanism 1234 with substantially the same shape as the transpalatal element 1204 of the shell 1202. The curved stop mechanism 1234 can be located at the apex of the transpalatal element 1204 and on the side of the transpalatal element 1204 facing the palate of the patient. The curved stop mechanism 1234 can be of the same material as the transpalatal element 1204, or of a different material.

Prior to expansion of the appliance 1200 (e.g., as shown in FIG. 12), the transpalatal element 1204 does not lie next to (e.g., adjacent to) the curved stop mechanism 1234. During expansion of the appliance 1200, the transpalatal element 1204 can gradually become adjacent to the curved stop mechanism 1234. That is, the curved stop mechanism 1234 can gradually provide mechanical force on the transpalatal element 1204 that is equal to and opposite of the force provided by the transpalatal element 1204 as the transpalatal element 1204 gradually becomes adjacent to the curved stop mechanism 1234. The mechanical force from the curved stop mechanism 1234 increases as the transpalatal element 1204 of the shell 1202 expands. In other words, the curved stop mechanism 1234 gradually stops expansion of the transpalatal element 1204 at the predefined expansion length, preventing the appliance 1200 from over expanding the space between the molars on each side of the patient's jaw and/or the palate of the patient, where the predefined expansion length can be based on a stage of a treatment plan.

Each of the stop mechanisms can be used in different stages of a treatment plan. For example, a sliding stop mechanism may be used in a first stage of a treatment plan, and a tension stop mechanism may be used in a second stage of the treatment plan. In other examples, different combinations of stop mechanisms (e.g., sliding stop mechanisms, tension stop mechanisms, and/or deflection limit stop mechanisms) may be used in different stages of a treatment plan.

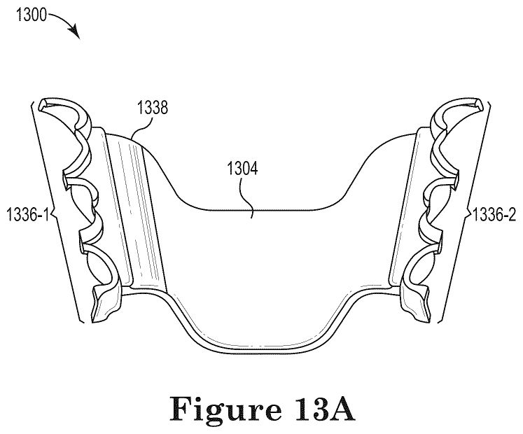

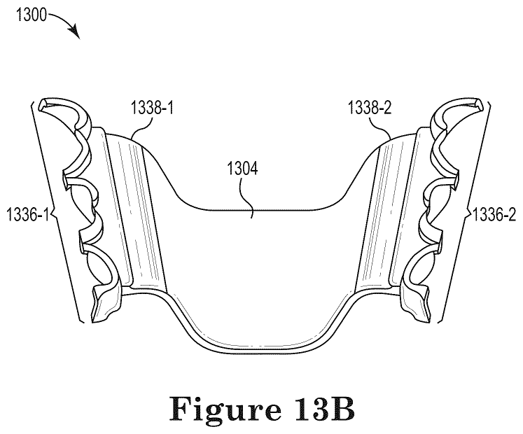

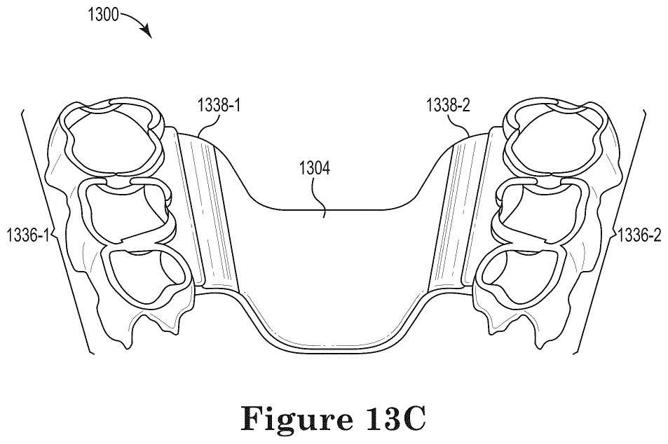

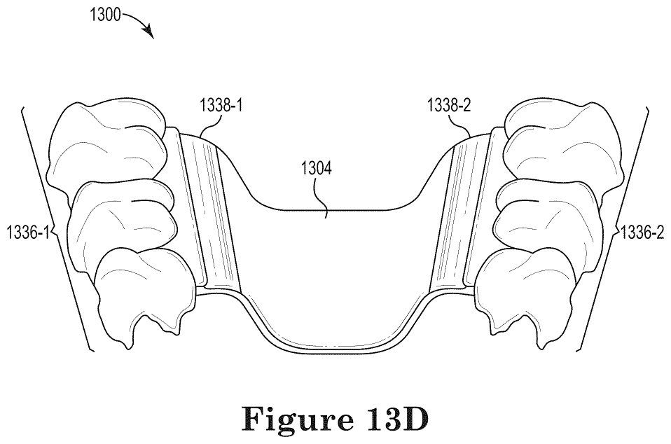

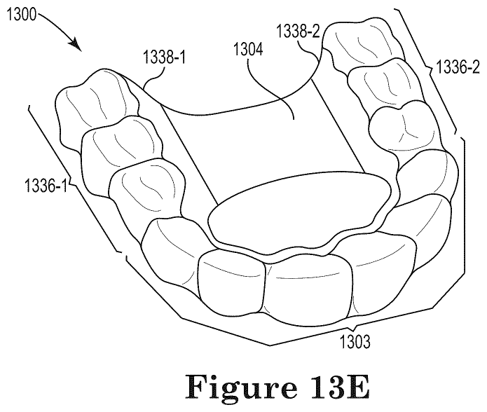

FIGS. 13A, 13B, 13C, 13D, and 13E illustrate examples of removable arch adjustment appliances according to a number of embodiments of the present disclosure. FIG. 13A illustrates a removable arch adjustment appliance including a regulating structure for a plurality of tooth engagement structures according to a number of embodiments of the present disclosure. As illustrated in FIG. 13A, the removable arch adjustment appliance 1300 does not have a shell with a plurality of cavities for the placement of teeth therein, but rather has a transpalatal element 1304, a first plurality of tooth engagement structures 1336-1 shaped to mate with molars of a patient along a first side of a dental arch of a patient, and a second plurality of tooth engagement structures 1336-2 shaped to mate with molars of a patient along a second side of the dental arch. Each of the individual tooth engagement structures is shaped to mate with a respective molar of the patient. As illustrated in FIG. 13A, each of the first plurality of tooth engagement structures 1336-1 and the second plurality of tooth engagement structures 1336-2 (referred to collectively as tooth engagement structures 1336) may extend along a portion of a side surface of a respective tooth of a patient. See FIGS. 13B-13C for contrasting examples of tooth engagement structures 1336.

The transpalatal element 1304 of the removable arch adjustment appliance 1300 can be configured to apply an expansion force via the tooth engagement structures 1336. The force can be applied outwardly from the transpalatal element 1304 in opposite directions via the first plurality of tooth engagement structures 1336-1 and via the second plurality of tooth engagement structures 1336-2 to expand a dental arch. The transpalatal element 1304 can expand across a surface of the mouth of the patient when the removable arch adjustment appliance 1300 is worn by the patient.

The transpalatal element 1304 can be shaped to span at least a portion of the surface of a patient's palate. In some embodiments, the transpalatal element 1304 can follow contours of a surface of the mouth of the patient when the removable arch adjustment appliance 1300 is worn by the patient. For example, the transpalatal element 1304 can be shaped to substantially follow the contours of the palate of the patient. This can be accomplished, for example, by scanning a mold of the surface of the palate of the patient or scanning the surface of the palate directly and then forming the surface of transpalatal element 1304 to substantially match the surface of the palate. The surfaces may not be identical, as the transpalatal element 1304 may be designed to be wider than the dental arch and therefore is not an identical copy of the scan data. As such, the surfaces may substantially match, but may not be identical.

The transpalatal element 1304 can be designed to expand a dental arch by applying an expansion force via the tooth engagement structures 1336. For example, such expansion can include moving the teeth of the patient to a wider position within the jaw, by expanding the palate of the patient, or a combination of the two. As indicated, some embodiments discussed herein may also expand the palate to a degree, but the dental expansion may be more gradual than some previous approaches (e.g., on the order of 0.5 mm per month as opposed to 0.5 mm per day). For instance, the width of the transpalatal element 1304 can be wider than the actual width of the dental arch in order to define the desired width of the dental arch. A width of a dental arch can be from molar to molar, from premolar to premolar, from canine to canine, or from any tooth on the left side to any tooth on the right side. For example, the width of the dental arch can include a distance between teeth of the left posterior side of the patient's dentition and teeth of the right posterior side of the patient's dentition. As an example, the transpalatal element 1304 can be 0.25 millimeters wider than the width of the dental arch. By the transpalatal element 1304 being wider than the width of the dental arch, it can apply force outwardly to the dental arch when worn by the patient.

The transpalatal element 1304 can have a width specific to a stage of a treatment plan. The transpalatal element 1304 can be designed to expand a dental arch to that specified width, which may be less than the full width to which the dental arch is to be expanded. The dental arch expansion can be incrementally accomplished by expanding the dental arch a little at a time over the use of several differently designed arch adjustment appliances according to the treatment plan. Or the dental arch may be over-expanded to compensate for incomplete biological response to the desired outcome, where the actual width of the dental arch is less than the width programmed or built into the stage(s) of the treatment plan which can provide a constant transverse expansion force to achieve slow palatal expansion.

The removable arch adjustment appliance 1300 can be flexible allowing it to be compressed enough such that the transpalatal element 1304 will fit within the dental arch and then begin to apply force via the tooth engagement structures 1336 once the compression is relaxed. For example, the patient can squeeze the removable arch adjustment appliance 1300 during insertion and then release the removable arch adjustment appliance 1300 after insertion, allowing force to be applied via the tooth engagement structures 1336.

The contours of the transpalatal element 1304 may be shaped in anticipation of a stretching of the palate during the expansion in order to better accommodate the seating of the removable arch adjustment appliance 1300 in the patient's mouth. The shape of the removable arch adjustment appliance 1300 can be designed to include an expected stretching of the patient's palate during dental expansion and/or a movement of the teeth. Such shaping can be achieved through treatment planning, as described herein, that accounts for expansion of the dental arch and/or movement of the teeth of the patient.

One side of the transpalatal element 1304 can be adjacent to and/or in contact with a tongue of the patient. The other side of the transpalatal element 1304 can be adjacent to and/or in contact with a surface of the patient's mouth (e.g., the palate of the patient's mouth). Using the scan data, the transpalatal element 1304 may be designed to contact the palate (e.g., if more support is desired) or it may be designed not to contact the palate (e.g., for patient comfort).

Design and fabrication of the removable arch adjustment appliance 1300 for some embodiments that include a transpalatal element 1304 that does not contact the palate can include raising the palatal contours in a vertical direction in a virtual or physical model of the palate so that any appliance which is formed over the physical model is slightly raised in comparison to the actual contours of the palate. In other words, a slight gap between the actual palate and the transpalatal element 1304 can be designed to be present. This gap allows the transpalatal element 1304 to apply force via the tooth engagement structures while not necessarily requiring an exact fit of the transpalatal element 1304 to the contours of the palate. Such a slight offset in the vertical dimension can reduce any disruption in speech, swallowing, or feel due to changes in tongue position that may otherwise result from wearing the removable arch adjustment appliance 1300. Raising the vertical dimension of the transpalatal element 1304 has the benefit of not needing perfect modeling of any non-linear stretching that might take place in the palate. This can greatly reduce the risk of uncomfortable pressure spots and sores caused by the removable arch adjustment appliance 1300. Having to relieve pressure spots in the appliance can be very time consuming for the doctor, and if the appliance is thin to begin with, such adjustments can lead to weakened areas in the appliance.

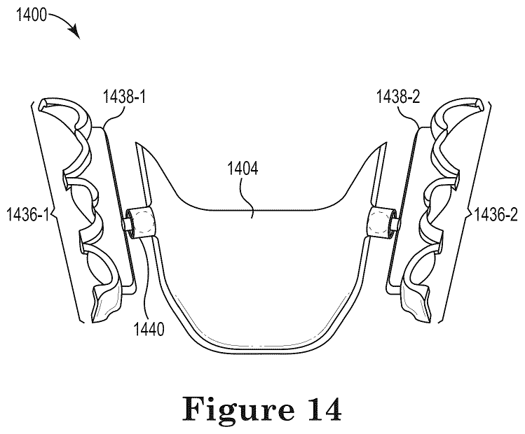

The removable arch adjustment appliance 1300 can include a regulating structure 1338. In FIG. 13A, the removable arch adjustment appliance 1300 includes a regulating structure on only one side of the removable arch adjustment appliance 1300. The regulating structure 1338 is illustrated generically in FIGS. 13A-13E and specifically in FIGS. 14-19. The discussion of the regulating structure 1338 with respect to FIGS. 13A-13E applies to each of the embodiments illustrated and described with respect to FIGS. 13A-19. The discussion of the regulating structures in FIGS. 14-19 may be specific to those individual embodiments.

FIG. 13B illustrates a removable arch adjustment appliance including regulating structures for a plurality of tooth engagement structures according to a number of embodiments of the present disclosure. The removable arch adjustment appliance 1300 can include a first regulating structure 1338-1 and a second regulating structure 1338-2 (referred to collectively as regulating structures 1338). In contrast to FIG. 13A, the removable arch adjustment appliance 1300 in FIG. 13B includes more than one regulating structure 1338. Although the remainder of the figures illustrate appliances with more than one regulating structure 1338, embodiments are not so limited as the removable arch adjustment appliance 1300 can include only one regulating structure 1338 in any embodiment.

The first regulating structure 1338-1 connected between the transpalatal element 1304 and the first plurality of tooth engagement structures 1336-1 is configured to balance and direct the expansion force from the transpalatal element 1304 to the first plurality of tooth engagement structures 1336-1. The second regulating structure 1338-2 connected between the transpalatal element 1304 and the second plurality of tooth engagement structures 1336-2 is configured to balance and direct the expansion force from the transpalatal element 1304 to the first plurality of tooth engagement structures 1336-2. The tooth engagement structures 1336 can contact at least one of a surface of a tooth or a surface of the patient's gingiva and impart a force thereto. The force imparted to the teeth or gingiva can originate from the transpalatal element 1304 and be balanced and directed to the tooth engagement structures 1336 via the regulating structures 1338. The first plurality of tooth engagement structures 1336-1 can be collectively connected to the first regulating structure 1338-1 and the second plurality of tooth engagement structures 1336-2 can be collectively connected to the second regulating structure 1338-2.

As noted above, applying an expansion force to more than one tooth on each side of the dental arch can result in uneven movement of the teeth, which may yield an undesired dental arch shape during the dental arch expansion process. For example, the roots of the teeth that are to be moved during the expansion process may begin to shift under different amounts of pressure (e.g., some teeth may be more strongly rooted than others). The regulating structures 1338 can balance and direct the expansion force so that the teeth move more evenly and the dental arch expansion process maintains a proper or desired shape of the dental arch. Such a balanced and directed application of the force generated by the transpalatal element 1304 can help prevent different teeth from moving differently in the first place. Furthermore, even if one tooth starts to move before the other teeth to which the expansion force is being applied, a regulating structure 1338 can balance the portion of the expansion force that is being generated by the transpalatal element 1304 for one side of the dental arch such that it is applied more evenly to the teeth.

In some embodiments, the tooth engagement structures 1336, the regulating structures 1338, and the transpalatal element 1304 of the removable arch adjustment appliance 1300 can comprise a unitary body. In this manner, a removable arch adjustment appliance 1300 can be formed that has two or more distinct material properties, but is unitary in nature (e.g., forms a single body that can be used by the patient even though it is formed of two or more materials). A material property can be a chemical property such as that of a composition or mixture or a physical property, such as a weight, elasticity, strength, etc. In various embodiments, the tooth engagement structures 1336, the regulating structures 1338, and the transpalatal element 1304 of the removable arch adjustment appliance 1300 can be fabricated from one material. In some embodiments, the removable arch adjustment appliance 1300 can be fabricated from multiple materials or can be manufactured in parts wherein the parts are made from different materials and are attached together to create the removable arch adjustment appliance 1300. Portions of the removable arch adjustment appliance 1300 may not be visible to people when they see the removable arch adjustment appliance 1300 in the patient's mouth and as such the material does not have to be clear, and this therefore allows for more options with regard to the choice of material that can be utilized.

In some embodiments, the transpalatal element 1304 can be formed of a first material and from a second material that is a different than the first material in at least one physical property. For example, the first material may be a polyurethane material and the second material may also be a polyurethane material with the same chemical formula, but of different hardness or rigidity due to greater crosslinking. Or, the first material can be of one chemical composition (e.g., polyurethane), and the second material of an entirely different chemical composition (e.g., polyvinyl chloride). In some embodiments, the second material is more resilient than the first material. This can be beneficial in embodiments, for example, where there is an initial need for a more rigid transpalatal element 1304 and then a more resilient transpalatal element 1304 later in treatment, among other situations where such an embodiment may be utilized.

In some embodiments, the second material can include, for instance, a more rigid material than the first material designed to provide greater resistance and/or force in a transverse direction against the posterior teeth (e.g., molars and bicuspids) of the dental arch. In various embodiments, this second material can be designed to impart force to the molars and/or other teeth on the jaw of the patient in order to either help preserve or change the transverse dimensions of the dental arch.

Rather than providing a strong force, such as 10 to 50 N for a short period of a few days to a few weeks, embodiments of the present disclosure can provide a lesser force, such as 3 to 9 N via the transpalatal element 1304, for a longer period, such as a month to six months. This force can be used, for example, to move palatal plates, move teeth outward, and/or maintain the teeth and/or jaw in a particular orientation while musculature and bone are adjusting to the orientation and to prevent movement of the teeth or jaw back toward their initial orientation. For example, a challenge of such an appliance is the need to retain the expansion while the bone is filling into the suture, long after the active expansion has taken place. The active expansion process may be completed within 2 or 3 weeks' time, but the retention period can last around 6 months while waiting for the gap between the maxillary halves to fill in with new bony tissue.

In some embodiments, a plurality of removable arch adjustment appliances 1300 can be worn by a patient successively to achieve gradual expansion (or constriction) of the dental arch. For instance, each of a plurality of arch adjustment appliances can include an incrementally wider width to expand the dental arch in incremental distances. In some such embodiments, since this dental arch expansion technique can be accomplished concurrently with other orthodontic treatments, the dental arch expansion can be accomplished over a series of removable arch adjustment appliances 1300 that will be utilized, for example, over a period of less than six months, thereby making any pain and/or discomfort of the patient more consistent and less arbitrary without prolonging the overall time for orthodontic treatment.

A physical model of the patient's oral anatomy can be created from a virtual model of the patient's oral anatomy. The patient's oral anatomy can include, for example, a number of teeth and interconnecting tissue, such as gingiva and/or the palate. The virtual model can be created from data obtained from scanning the patient's oral anatomy directly or from scanning a mold (e.g., a plaster mold) of the patient's oral anatomy. The virtual model can be modified to create a treatment plan that can identify the patient, define various stages of the treatment plan and corresponding variations of the virtual model specific to each stage.

In some embodiments, the physical model can be manufactured by using a Computer-aided Design (CAD) virtual model file in a rapid prototyping process, such as, for example, a Computer-aided manufacturing (CAM) milling, stereolithography, 3D printing, fused deposition modeling (FDM), selective laser sintering (SLS), and/or photolithography process. Advantages of such techniques can include, for example, that multiple materials can be used in a single build, various cross sectional thickness's can be designed and built for rigidity, and easy fabrication of a complex geometry of the oral anatomy. The virtual model can be hollowed out or “shelled” before it is sent for manufacturing to save on material cost if printed, for example.

In some embodiments, the removable arch adjustment appliance 1300, or a portion thereof, can be formed using a thermoforming and/or vacuum forming process. For example, one or more sheets of polymeric material can be thermoformed and/or vacuum formed over the physical model. A sheet may be heated and multiple sheets may be heated to different temperatures. In some examples, the sheets may be layered. A sheet can have varying thicknesses (beyond natural variations in thickness during the shaping process as it conforms to the mold shape) in some portions to provide increased or reduced strength or other physical material properties across the removable arch adjustment appliance 1300. The removable arch adjustment appliance 1300 and/or parts thereof may be transparent, semi-transparent, or opaque in such a way as to emulate a natural tooth shade.

In some embodiments, the removable arch adjustment appliance 1300, or a portion thereof, can be formed by a rapid prototyping process, such as, for example, by a Computer-aided manufacturing (CAM) milling, stereolithography, 3D printing, fused deposition modeling (FDM), selective laser sintering (SLS), and/or photolithography. Advantages of such techniques can include, for example, that multiple materials can be used in a single build, various cross sectional thickness's can be designed and built for rigidity, and easy fabrication of a complex organic geometry.

FIG. 13C illustrates a removable arch adjustment appliance including regulating structures for a plurality of tooth engagement structures according to a number of embodiments of the present disclosure. The removable arch adjustment appliance 1300 illustrated and described with respect to FIG. 13C is analogous to the removable arch adjustment appliance 1300 illustrated and described with respect to FIG. 13B, except that the tooth engagement structures 1336 are slightly different. In the embodiment illustrated in FIG. 13C, the first plurality of tooth engagement structures 1336-1 are shaped to mate with the molars of the patient along the first side of the dental arch by extending substantially around the side surfaces of the molars. Likewise, the second plurality of tooth engagement structures 1336-2 are shaped to mate with the molars of the patient along the second side of the dental arch by extending substantially around the side surfaces of the molars. For example, the tooth engagement structures 1336 can extend around the entire side surfaces of the molars to surround the molars. Such embodiments may provide a more secure fit for the removable arch adjustment appliance 1300 in the mouth of the patient, may be able to impart more force, and may be able to control application of that force in one or more directions with respect to a particular tooth. This may, in some instances, allow the position or orientation of a tooth to be adjusted while the removable arch adjustment appliance 1300 is expanding the palate of the patient.

FIG. 13D illustrates a removable arch adjustment appliance including regulating structures for a plurality of tooth engagement structures according to a number of embodiments of the present disclosure. The removable arch adjustment appliance 1300 illustrated and described with respect to FIG. 13D is analogous to the removable arch adjustment appliance 1300 illustrated and described with respect to FIG. 13B, except that the tooth engagement structures 1336 are slightly different. In the embodiment illustrated in FIG. 13D, the first plurality of tooth engagement structures 1336-1 comprise cavities that are shaped to mate with the molars of the patient along the first side of the dental arch. Each of the cavities can be shaped to receive a respective molar and to mate with side surfaces and an occlusal surface of the molar. Such embodiments may provide a more secure fit for the removable arch adjustment appliance 1300 in the mouth of the patient, may be able to impart more force, and may be able to control application of that force in one or more directions with respect to a particular tooth. This may, in some instances, allow the position or orientation of a tooth to be adjusted while the removable arch adjustment appliance 1300 is expanding the palate of the patient.

In some embodiments, the removable arch adjustment appliance 1300 can be overlaid over an existing appliance used to adjust tooth positioning and/or orientation. For example, in an embodiment such as the one illustrated in FIG. 13D, the tooth engagement structures 1336 (cavities) can be sized to fit over cavities of an aligner appliance used for aligning one or more teeth or a retainer appliance used to maintain the position of one or more teeth. The aligner appliance and/or the removable arch adjustment appliance 1300 may have features thereon to lock the two appliances together or they may be affixed together by other means (e.g., frictionally and/or via adhesives, etc.).

FIG. 13E illustrates a removable arch adjustment appliance including cavities and regulating structures for a plurality of tooth engagement structures according to a number of embodiments of the present disclosure. The removable arch adjustment appliance 1300 illustrated and described with respect to FIG. 13E is analogous to the removable arch adjustment appliance 1300 illustrated and described with respect to FIG. 13D, except that the removable arch adjustment appliance 1300 further comprises a shell including a plurality of cavities 1303 shaped to receive other teeth of the patient (e.g., premolars, canines, incisors). The plurality of cavities 1303, the first plurality of tooth engagement structures 1336-1, and the second plurality of tooth engagement structures 1336-2, which are also cavities in this embodiment, form an arch of the removable arch adjustment appliance 1300 that corresponds to the dental arch. In this embodiment, the tooth engagement structures 1336 are part of the shell along with the plurality of cavities.

The shell can be formed of a material having resilient properties that generally conforms to the other teeth of the patient, but is slightly out of alignment with a current tooth configuration of the patient to provide force to change the current tooth configuration. The shell may be designed to fit over a number of, or in many instances all, teeth present in the jaw. The shell can include an interior surface (e.g., adjacent to a surface of the teeth place therein) and an exterior surface. The interior surface is configured to receive and a apply forces to the teeth therein to reposition a number of teeth of the patient, for example. Force can also be applied outwardly from the transpalatal element 1304 in opposite directions via the tooth engagement structures 1336 as balanced and directed by the regulating structures 1338 to expand a dental arch. In some embodiments, the removable arch adjustment appliance 1300 can be used for repositioning the number of teeth of the patient concurrently with expansion of the dental arch.

The simultaneous treatment of misalignment of a patient's dental arch in conjunction with teeth alignment issues (e.g., rotation, tipping, etc.) can, for example, potentially eliminate a second phase of what would otherwise be a two phase treatment protocol, make the second phase less complex or a little more comfortable for the patient, or shorten treatment times when compared to current linear two-phase treatment protocols that first treat the misalignment of a patient's dental arch followed by treatment of misalignment of the patient's teeth. The transpalatal element 1304 can, in accordance with a number of embodiments, avoid and/or not interfere with engagement of the shell with the teeth therein and thereby allow for correction of various tooth misalignment issues during the dental arch expansion process so that both dental arch expansion and alignment correction occurs in tandem rather than as separate phases.

In some embodiments of the present disclosure, a particular removable arch adjustment appliance 1300 can be specific to a stage of a treatment plan. For instance, the treatment plan can call for a series of removable arch adjustment appliance 1300 designed to incrementally implement the treatment plan. Each of the series of removable arch adjustment appliance 1300 can be specific to a stage of the incremental treatment plan, for instance. The series can be used for treating misalignment of teeth of a patient and/or misalignment of one or more dental arches. In some such embodiments, one dental arch can be expanded while the other dental arch is not expanded or both dental arches can be expanded simultaneously. Or one dental arch can be expanded while the other one is contracted.

A system of removable arch adjustment appliances 1300 can include a shell having a plurality of cavities 1303 shaped to receive teeth of a patient, a transpalatal element 1304 configured to apply an expansion force via the shell in a transverse direction, and a regulating structure 1338 connected between the transpalatal element 1304 and the shell and configured to balance and direct the expansion force from the transpalatal element 1304 to the shell according to a particular stage of a treatment plan.

The transpalatal element 1304 can have a width specific to a particular stage of a treatment plan. For example, a system can include a plurality of removable arch adjustment appliances 1300 designed to incrementally implement the treatment plan. The transpalatal element 1304 of a first removable arch adjustment appliance 1300 can have a width specific to a first stage of the treatment plan and the transpalatal element 1304 of a second removable arch adjustment appliance 1300 can have a width specific to a second stage of the treatment plan. For example, the second removable arch adjustment appliance 1300 can be designed to provide force to move at least one of the teeth and to apply the expansion force via the shell concurrently. The regulating structure 1338 of the second removable arch adjustment appliance 1300 can be a same type or a different type of regulating structure 1338 as that of the first removable arch adjustment appliance 1300. FIGS. 14-19 illustrate some specific examples of different types of regulating structures 1338.

In some embodiments, a removable arch adjustment appliance 1300 can be formed by thermoforming. For example, a removable shell can be formed over a set of molded teeth. The removable shell can include a plurality of cavities 103 formed therein, as well as the tooth engagement structures 1336. The regulating structures 1338 and the transpalatal element 1304 can be formed of the same material as the removable shell or different materials. The regulating structures 1338 and the transpalatal element 1304 can be connected to the removable shell to form the removable arch adjustment appliance 1300.

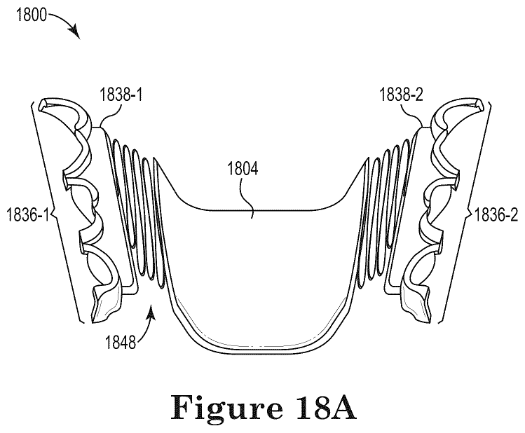

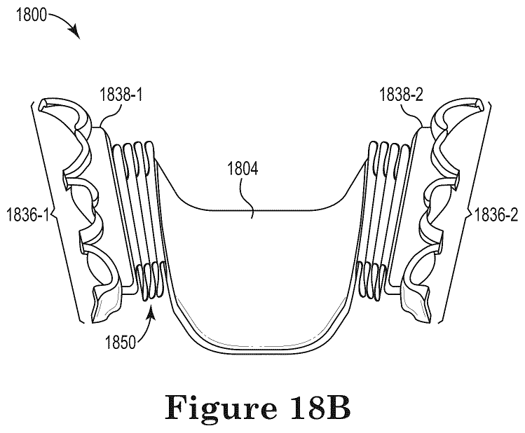

The connection can be achieved by thermoforming the removable shell over the set of molded teeth with at least a portion of the regulating structures 1338 placed within the set of molded teeth (e.g., encapsulated). The connection can be achieved via direct fabrication of the regulating structures 1338 and the transpalatal element 1304 from a virtual model, then by fusing the components together (e.g., ultrasonic welding). The connection can be achieved by adhering the regulating structures 1338 and the transpalatal element 1304 using an agent (e.g., a binding material) subsequent to forming the regulating structures 1338, the transpalatal element 1304, and the removable shell. In some embodiments, the regulating structures 1338 can be thermoformed with the material removable shell and later have portions of the material removed to provide the functionality of the regulating structures (e.g., as in the embodiment illustrated in FIGS. 18A-18B).

FIGS. 14-19 illustrate arch adjustment appliances that are analogous to the removable arch adjustment appliances 1300 illustrated in FIGS. 13A-13E, except that specific examples of the regulating structures are illustrated. For ease of illustration and explanation, the appliances illustrated in FIGS. 14-18 are shown including tooth engagement structures analogous to those illustrated in FIG. 13B. However, embodiments are not so limited, as the embodiments of FIGS. 14-19 can include tooth engagement structures analogous to those illustrated in FIGS. 13C-13D. Likewise, the embodiments of FIGS. 14-19 can include a shell analogous to that illustrated and described with respect to FIG. 13E.

FIG. 14 illustrates an arch adjustment appliance including a regulating structure comprising a ball joint according to a number of embodiments of the present disclosure. As illustrated in FIG. 14, the removable arch adjustment appliance 1400 includes a transpalatal element 1404, a first plurality of tooth engagement structures 1436-1, a second plurality of tooth engagement structures 1436-2, a first regulating structure 1438-1, and a second regulating structure 1438-2. In the embodiment of FIG. 14, the regulating structures 1438 comprise ball joints 1440.

The regulating structures 1438 can balance and direct the expansion force so that the teeth move more evenly and the dental arch expansion process maintains a proper or desired shape of the dental arch. The ball joints 1440 add three degrees of freedom (rotation) for the regulating structures 1438 versus a solid plane between the transpalatal element 1404 and the tooth engagement structures 1436. This allows rolling, pitching, and yawing of the tooth engagement structures 1436 relative to the transpalatal element 1404 to apply force more evenly to the patient's teeth.

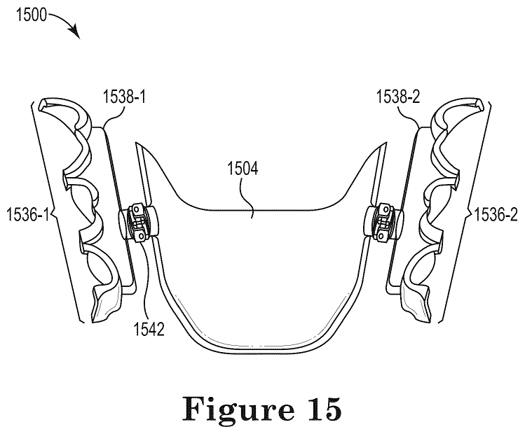

FIG. 15 illustrates an arch adjustment appliance including a regulating structure comprising a universal joint according to a number of embodiments of the present disclosure. As illustrated in FIG. 15, the removable arch adjustment appliance 1500 includes a transpalatal element 1504, a first plurality of tooth engagement structures 1536-1, a second plurality of tooth engagement structures 1536-2, a first regulating structure 1538-1, and a second regulating structure 1538-2. In the embodiment of FIG. 15, the regulating structures 1538 comprise universal joints 1542.

The regulating structures 1538 can balance and direct the expansion force so that the teeth move more evenly and the dental arch expansion process maintains a proper or desired shape of the dental arch. The universal joints 1542 add three degrees of freedom (rotation) for the regulating structures 1538 versus a solid plane between the transpalatal element 1504 and the tooth engagement structures 1536. This allows rolling, pitching, and yawing of the tooth engagement structures 1536 relative to the transpalatal element 1504 to apply force more evenly to the patient's teeth.

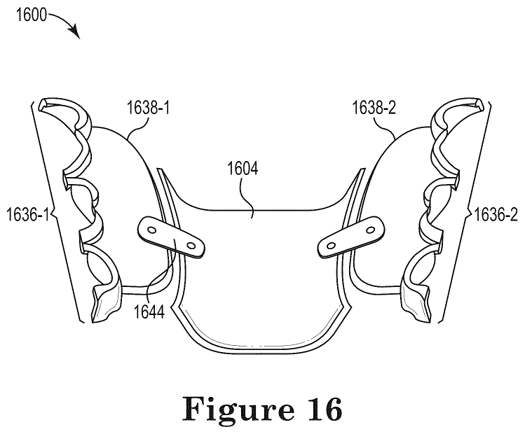

FIG. 16 illustrates an arch adjustment appliance including a regulating structure comprising an arm according to a number of embodiments of the present disclosure. As illustrated in FIG. 16, the removable arch adjustment appliance 1600 includes a transpalatal element 1604, a first plurality of tooth engagement structures 1636-1, a second plurality of tooth engagement structures 1636-2, a first regulating structure 1638-1, and a second regulating structure 1638-2. In the embodiment of FIG. 16, the regulating structures 1638 each comprise an arm 1644. The arms 1644 can be pinned to the toot engagement structures 1636 and fixed to the transpalatal element 1604.

The regulating structures 1638 can balance and direct the expansion force so that the teeth move more evenly and the dental arch expansion process maintains a proper or desired shape of the dental arch. The arms 1644 add one degree of freedom (rotation) for the regulating structures 1638 versus a solid plane between the transpalatal element 1604 and the tooth engagement structures 1636. This allows for rotation of the tooth engagement structures 1636 relative to the transpalatal element 1604 to apply force more evenly to the patient's teeth.

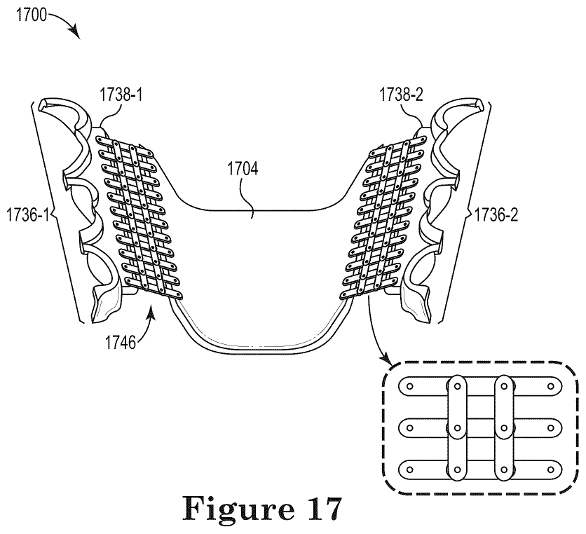

FIG. 17 illustrates an arch adjustment appliance including a regulating structure comprising a mesh of arms according to a number of embodiments of the present disclosure. As illustrated in FIG. 17, the removable arch adjustment appliance 1700 includes a transpalatal element 1704, a first plurality of tooth engagement structures 1736-1, a second plurality of tooth engagement structures 1736-2, a first regulating structure 1736-1, and a second regulating structure 1736-2. In the embodiment of FIG. 17, the regulating structures 1736 comprise meshes of arms 1746. The meshes of arms 1746 can have pinned connections between the arms.

The regulating structures 1736 can balance and direct the expansion force so that the teeth move more evenly and the dental arch expansion process maintains a proper or desired shape of the dental arch. The meshes of arms 1746 add two degrees of freedom (one translation and one rotation) for the regulating structures 1736 versus a solid plane between the transpalatal element 1704 and the tooth engagement structures 1736. This allows for rotation and translation of the tooth engagement structures 1736 relative to the transpalatal element 1704 to apply force more evenly to the patient's teeth.

FIG. 18A illustrates an arch adjustment appliance including a regulating structure comprising a horizontal accordion spring according to a number of embodiments of the present disclosure. FIG. 18B illustrates a removable arch adjustment appliance including a regulating structure comprising a vertical accordion spring according to a number of embodiments of the present disclosure. As illustrated in FIGS. 18A-18B, the removable arch adjustment appliance 1800 includes a transpalatal element 1804, a first plurality of tooth engagement structures 1836-1, a second plurality of tooth engagement structures 1836-2, a first regulating structure 1838-1, and a second regulating structure 1838-2. In the embodiment of FIG. 18A, the regulating structures 1838 comprise a portion of the removable arch adjustment appliance 1800 with areas of material removed therefrom yielding a shape and functionality of a horizontal accordion spring 1848. In the embodiment of FIG. 18B, the regulating structures 1838 comprise a portion of the removable arch adjustment appliance 1800 with areas of material removed therefrom yielding a shape and functionality of a vertical accordion spring 1850.

The regulating structures 1838 can balance and direct the expansion force so that the teeth move more evenly and the dental arch expansion process maintains a proper or desired shape of the dental arch. The horizontal accordion springs 1848 or the vertical accordion springs 1850 add two degrees of freedom (one translation and one rotation) for the regulating structures 1838 versus a solid plane between the transpalatal element 1804 and the tooth engagement structures 1836. This allows for rotation and translation of the tooth engagement structures 1836 relative to the transpalatal element 1804 to apply force more evenly to the patient's teeth.

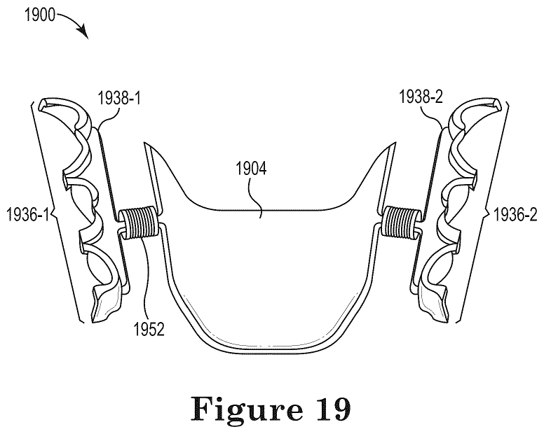

FIG. 19 illustrates a removable arch adjustment appliance including a regulating structure comprising a coupling spring according to a number of embodiments of the present disclosure. As illustrated in FIG. 19, the removable arch adjustment appliance 1900 includes a transpalatal element 1904, a first plurality of tooth engagement structures 1936-1, a second plurality of tooth engagement structures 1936-2, a first regulating structure 1938-1, and a second regulating structure 1938-2. In the embodiment of FIG. 19, the regulating structures 1938 comprise coupling springs 1952.

The regulating structures 1938 can balance and direct the expansion force so that the teeth move more evenly and the dental arch expansion process maintains a proper or desired shape of the dental arch. The transpalatal arch element 1904 can terminate in a first shaft proximal to the first regulating structure 1938-1. The first plurality of tooth engagement structures 1936-1 can terminate in a second shaft proximal to the first regulating structure 1938-1. The coupling spring 1952 can dampen misalignment between the first shaft and the second shaft.

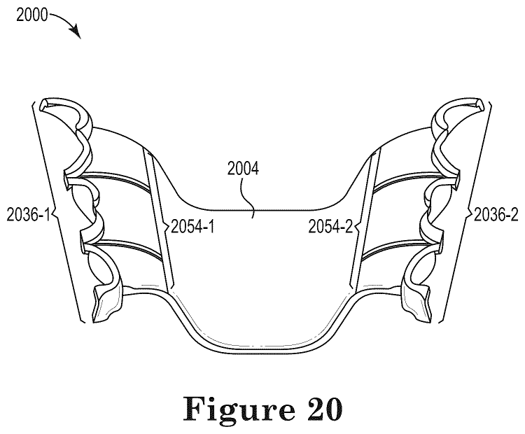

FIG. 20 illustrates a removable arch adjustment appliance including regulating structures for individual tooth engagement structures according to a number of embodiments of the present disclosure. The removable arch adjustment appliance 2000 can include a first plurality of tooth engagement structures 2036-1 shaped to mate with molars of a patient along a first side of a dental arch. The removable arch adjustment appliance 2000 can include a second plurality of tooth engagement structures 2036-2 shaped to mate with molars of the patient along a second side of the dental arch. The tooth engagement structures 2036 are analogous to the tooth engagement structures 1336 illustrated and described with respect to FIGS. 13A-13D. Although illustrated as being analogous to those in FIGS. 13A-13B, the tooth engagement structures of FIGS. 13C-13D can alternatively be a part of the removable arch adjustment appliance 2000 in FIG. 20. Likewise, although not specifically illustrated, the appliance 2000 can include a shell analogous to that illustrated and described with respect to FIG. 13E.

The removable arch adjustment appliance 2000 includes a transpalatal element 2004 configured to apply an expansion force via the first plurality of tooth engagement structures 2036-1 and to the second plurality of tooth engagement structures 2036-2. The transpalatal element 2004 is analogous to the transpalatal element illustrated and described with respect to FIGS. 13A-13E.

The removable arch adjustment appliance 2000 can include a first plurality of regulating structures 2054-1 each connected between the transpalatal element 2004 and a respective one of the first plurality of tooth engagement structures 2036-1. Each of the first plurality of tooth engagement structures 2054-1 is configured to balance and direct the expansion force from the transpalatal element 2004 via a respective one of the first plurality of tooth engagement structures 2036-1 to a respective tooth of the patient.

The removable arch adjustment appliance 2000 can include a second plurality of regulating structures 2054-2 each connected between the transpalatal element 2004 and a respective one of the second plurality of tooth engagement structures 2036-2. Each of the second plurality of tooth engagement structures 2054-2 is configured to balance and direct the expansion force from the transpalatal element 2004 via a respective one of the second plurality of tooth engagement structures 2036-2 to a respective tooth of the patient.

The first plurality of regulating structures 2054-1 are individually connected to the first plurality of tooth engagement structures 2036-1 and the second plurality of regulating structures 2054-2 are individually connected to the second plurality of tooth engagement structures 2036-2. Thus, the removable arch adjustment appliance 2000 is analogous to the removable arch adjustment appliance 1300 illustrated and described with respect to FIGS. 13A-13E, except that the first plurality of regulating structures 2054-1 and the second plurality of regulating structures 2054-2 (referred to collectively as regulating structures 2054) are individually connected to respective tooth engagement structures 2036 in the removable arch adjustment appliance 2000 as opposed to being collectively connected to the tooth engagement structures 1336 on either side of the dental arch in the removable arch adjustment appliance 1300. Individually connecting the regulating structures 2054 to the tooth engagement structures 2036 can allow for more individualized application of the force from the transpalatal element 2004 via the tooth engagement structures 2036 to the teeth of the patient versus having a single regulating structure for the tooth engagement structures 2036.

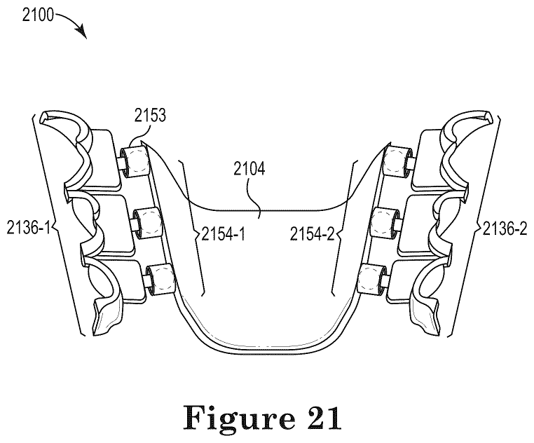

The regulating structures 2054 are illustrated generically in FIG. 20 and specifically in FIGS. 21-25. The discussion of the regulating structures 2054 with respect to FIG. 20 applies to each of the embodiments illustrated and described with respect to FIGS. 21-25. The discussion of the regulating structures in FIGS. 21-25 may be specific to those individual embodiments.

FIGS. 21-25 illustrate arch adjustment appliances that are analogous to the removable arch adjustment appliance 2000 illustrated and described with respect to FIG. 20, except that specific examples of the regulating structures are illustrated. For ease of illustration and explanation, the appliances illustrated in FIGS. 21-25 are shown including tooth engagement structures analogous to those illustrated in FIGS. 13A-13B. However, embodiments are not so limited, as the embodiments of FIGS. 21-25 can include tooth engagement structures analogous to those illustrated in FIGS. 13C-13D. Likewise, the embodiments of FIGS. 21-25 can include a shell analogous to that illustrated and described with respect to FIG. 13E.

FIG. 21 illustrates a removable arch adjustment appliance including regulating structures for individual tooth engagement structures comprising ball joint s according to a number of embodiments of the present disclosure. As illustrated in FIG. 21, the removable arch adjustment appliance 2100 includes a transpalatal element 2104, a first plurality of tooth engagement structures 2136-1, a second plurality of tooth engagement structures 2136-2, a first plurality of regulating structures 2154-1, and a second plurality of regulating structures 2154-2. In the embodiment of FIG. 21, the regulating structures 2154 each comprise a ball joint 2153.

The regulating structures 2154 can balance and direct the expansion force so that the teeth move more evenly and the dental arch expansion process maintains a proper or desired shape of the dental arch. The ball joints 2153 add three degrees of freedom (rotation) for the regulating structures 2154 versus a solid plane between the transpalatal element 2104 and the tooth engagement structures 2136. This allows rolling, pitching, and yawing of the tooth engagement structures 2136 relative to the transpalatal element 2104 to apply force more evenly to the patient's teeth.

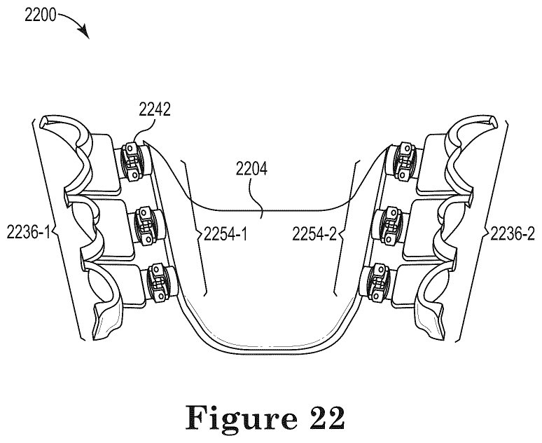

FIG. 22 illustrates a removable arch adjustment appliance including regulating structures for individual tooth engagement structures comprising universal joints according to a number of embodiments of the present disclosure. As illustrated in FIG. 22, the removable arch adjustment appliance 2200 includes a transpalatal element 2204, a first plurality of tooth engagement structures 2236-1, a second plurality of tooth engagement structures 2236-2, a first plurality of regulating structures 2254-1, and a second plurality of regulating structures 2254-2. In the embodiment of FIG. 22, the regulating structures 2254 each comprise a universal joint 2242.

The regulating structures 2254 can balance and direct the expansion force so that the teeth move more evenly and the dental arch expansion process maintains a proper or desired shape of the dental arch. The universal joints 2242 add three degrees of freedom (rotation) for the regulating structures 2254 versus a solid plane between the transpalatal element 2204 and the tooth engagement structures 2236. This allows rolling, pitching, and yawing of the tooth engagement structures 2236 relative to the transpalatal element 2204 to apply force more evenly to the patient's teeth.

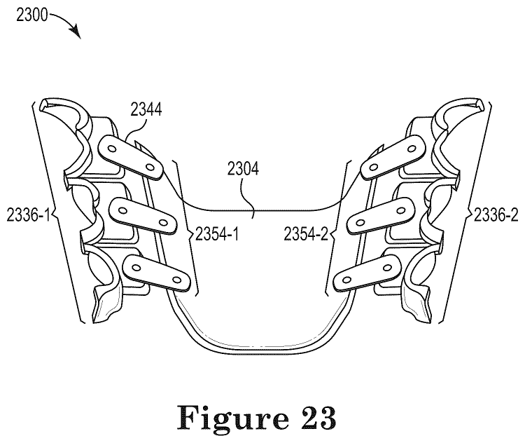

FIG. 23 illustrates a removable arch adjustment appliance including regulating structures for individual tooth engagement structures comprising arms according to a number of embodiments of the present disclosure. As illustrated in FIG. 23, the removable arch adjustment appliance 2300 includes a transpalatal element 2304, a first plurality of tooth engagement structures 2336-1, a second plurality of tooth engagement structures 2336-2, a first plurality of regulating structures 2354-1, and a second plurality of regulating structures 2354-2. In the embodiment of FIG. 23, the regulating structures 2354 each comprise an arm 2344. Each of the arms 2344 can be pinned to a respective one of the tooth engagement structures 2336 and fixed to the transpalatal element 2304.

The regulating structures 2354 can balance and direct the expansion force so that the teeth move more evenly and the dental arch expansion process maintains a proper or desired shape of the dental arch. The arms 2344 add one degree of freedom (rotation) for the regulating structures 2354 versus a solid plane between the transpalatal element 2304 and the tooth engagement structures 2336. This allows for rotation of the tooth engagement structures 2336 relative to the transpalatal element 2304 to apply force more evenly to the patient's teeth.

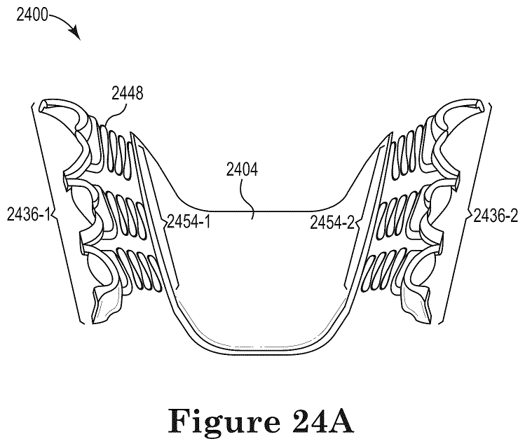

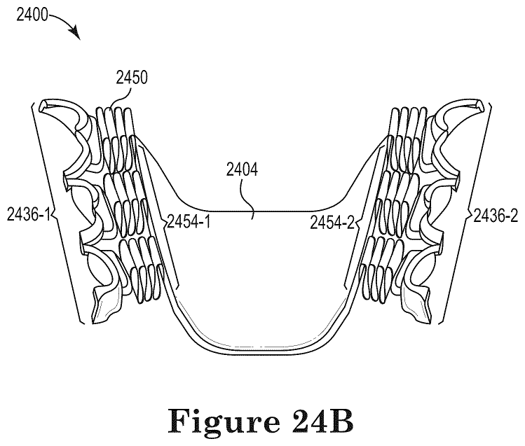

FIG. 24A illustrates a removable arch adjustment appliance including regulating structures for individual tooth engagement structures comprising horizontal accordion springs according to a number of embodiments of the present disclosure. FIG. 24B illustrates a removable arch adjustment appliance including regulating structures for individual tooth engagement structures comprising vertical accordion springs according to a number of embodiments of the present disclosure. As illustrated in FIGS. 24A-24B, the removable arch adjustment appliance 2400 includes a transpalatal element 2404, a first plurality of tooth engagement structures 2436-1, a second plurality of tooth engagement structures 2436-2, a first plurality of regulating structures 2454-1, and a second plurality of regulating structures 2454-2. In the embodiment of FIG. 24A, each of the regulating structures 2454 comprise a portion of the removable arch adjustment appliance 2400 with areas of material removed therefrom yielding a shape and functionality of horizontal accordion springs 2448. In the embodiment of FIG. 24B, each of the regulating structures 2454 comprise a portion of the removable arch adjustment appliance 2400 with areas of material removed therefrom yielding a shape and functionality of horizontal accordion springs 2450.

The regulating structures 2454 can balance and direct the expansion force so that the teeth move more evenly and the dental arch expansion process maintains a proper or desired shape of the dental arch. The horizontal accordion springs 2448 or vertical accordion springs 2450 add two degrees of freedom (one translation and one rotation) for the regulating structures 2454 versus a solid plane between the transpalatal element 2404 and the tooth engagement structures 2436. This allows for rotation and translation of the tooth engagement structures 2436 relative to the transpalatal element 2404 to apply force more evenly to the patient's teeth.

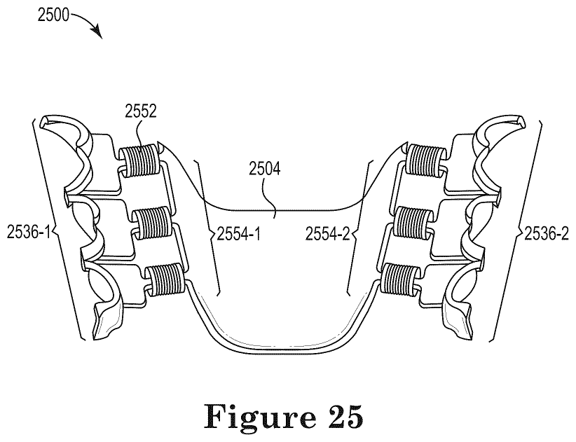

FIG. 25 illustrates a removable arch adjustment appliance including regulating structures for individual tooth engagement structures comprising coupling springs according to a number of embodiments of the present disclosure. As illustrated in FIG. 25, the removable arch adjustment appliance 2500 includes a transpalatal element 2504, a first plurality of tooth engagement structures 2536-1, a second plurality of tooth engagement structures 2536-2, a first plurality of regulating structures 2554-1, and a second plurality of regulating structures 2554-2. In the embodiment of FIG. 25, the regulating structures 2554 each comprise a coupling spring 2552.

The regulating structures 2554 can balance and direct the expansion force so that the teeth move more evenly and the dental arch expansion process maintains a proper or desired shape of the dental arch. The transpalatal arch element 2504 can terminate in a first shaft proximal to the first plurality of regulating structures 2554-1. The first plurality of tooth engagement structures 2536-1 can terminate in a second shaft proximal to the first plurality of regulating structure 2554-1. The coupling spring 2552 can dampen misalignment between the first shaft and the second shaft.

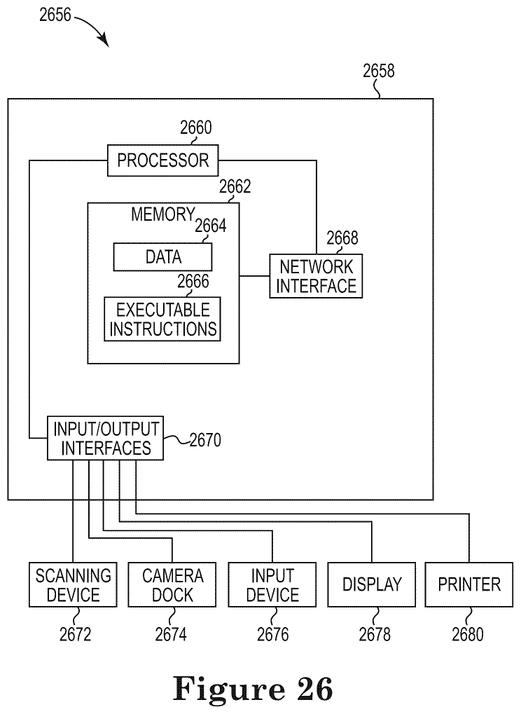

FIG. 26 illustrates an example computing device readable medium 2656 having executable instructions that can be executed by a processor to perform a method according to one or more embodiments of the present disclosure. For instance, a computing device 2658 can have a number of components coupled thereto. The computing device 2658 can include a processor 2660 and a memory 2662. The memory 2662 can have various types of information including data 2664 and executable instructions 2666, as discussed herein.

The processor 2660 can execute instructions 2666 that are stored on an internal or external non-transitory computer device readable medium (CRM). A non-transitory CRM, as used herein, can include volatile and/or non-volatile memory. Volatile memory can include memory that depends upon power to store information, such as various types of dynamic random access memory (DRAM), among others. Non-volatile memory can include memory that does not depend upon power to store information.

Memory 2662 and/or the processor 2660 may be located on the computing device 2658 or off the computing device 2658, in some embodiments. As such, as illustrated in the embodiment of FIG. 26, the computing device 2658 can include a network interface 2668. Such an interface 2668 can allow for processing on another networked computing device, can be used to obtain information about the patient, and/or can be used to obtain data and/or executable instructions for use with various embodiments provided herein.

As illustrated in the embodiment of FIG. 26, the computing device 2658 can include one or more input and/or output interfaces 2670. Such interfaces 2670 can be used to connect the computing device 2658 with one or more input and/or output devices 2672, 2674, 2676, 2678, 2680.

For example, in the embodiment illustrated in FIG. 26, the input and/or output devices can include a scanning device 2672, a camera dock 2674, an input device 2676 (e.g., a mouse, a keyboard, etc.), a display device 2678 (e.g., a monitor), a printer 2680, and/or one or more other input devices. The input/output interfaces 2670 can receive executable instructions and/or data, storable in the data storage device (e.g., memory), representing a virtual dental model of a patient's dentition.

In some embodiments, the scanning device 2672 can be configured to scan one or more physical dental models of a patient's dentition. In one or more embodiments, the scanning device 2672 can be configured to scan the patient's dentition and/or dental appliance directly. The scanning device 2672 can be configured to input data into the computing device 2658.

In some embodiments, the camera dock 2674 can receive an input from an imaging device (e.g., a 2D or 3D imaging device) such as a virtual camera, a printed photograph scanner, and/or other suitable imaging device. The input from the imaging device can, for example, be stored in memory 2662.

The processor 2660 can execute instructions to provide a visual indication of a treatment plan, a dental appliance, and/or a portion of a transpalatal element or stop mechanism on the display 2678. The computing device 2658 can be configured to allow a treatment professional or other user to input treatment goals. Input received can be sent to the processor 2660 as data 2664 and/or can be stored in memory 2662.

Such connectivity can allow for the input and/or output of data and/or instructions among other types of information. Some embodiments may be distributed among various computing devices within one or more networks, and such systems as illustrated in FIG. 26 can be beneficial in allowing for the capture, calculation, and/or analysis of information discussed herein.

The processor 2660, in association with the data storage device (e.g., memory 2662), can be associated with the data 2664. The processor 2660, in association with the memory 2662, can store and/or utilize data 2664 and/or execute instructions 2666 for designing a virtual appliance, including a transpalatal element, a regulating structure, a stop mechanism for a specific stage of a treatment plan and/or a series of virtual appliances for a treatment plan. Such data can include the virtual dental model and/or virtual model of a surface of a patient's mouth (e.g., palate and/or floor of the mouth).

The processor 2660 coupled to the memory 2662 can cause the computing device 2658 to determine a treatment plan to expand at least one of a space between the molars on each side of a patient's jaw or the palate of the patient. The treatment plan can include expanding at least one of the space between the molars on each side of a patient's jaw or palate of the patient by a first incremental distance (e.g., first incremental expansion length) using a first virtual appliance, wherein the first virtual appliance includes a shell having a plurality of cavities formed therein and shaped to receive teeth of the patient. The shell of the first virtual appliance can include an elastic transpalatal element with a predetermined force characteristic that spans the space between the molars on each side of the patient's jaw and provides force to expand at least one of the spaces between the molars on each side of the patient's jaw or the palate of the patient. The transpalatal element of the first virtual appliance can include a number of force control elements and/or regulating structures to control the force provided by the transpalatal element. The first virtual appliance can, in addition or alternatively, include a stop mechanism located on the shell to provide a mechanical force on the transpalatal element of the shell of the first appliance to reduce the force provided by the transpalatal element that expands the at least one of the space between the molars on each side of the patient's jaw or the palate of the patient. The transpalatal element of the shell of the first appliance, the force control elements, and/or the stop mechanism can be specific to a stage of a treatment plan and can be shaped based on physical data of the space between the molars on each side of the patient's jaw or the palate of the patient.

The treatment plan can include expanding at least one of the space between the molars on each side of a patient's jaw or palate of the patient by a second incremental distance (e.g., second incremental expansion length) using a second virtual appliance, wherein the second virtual appliance includes a shell having a plurality of cavities formed therein and shaped to receive teeth of the patient. The shell of the second virtual appliance can include an elastic transpalatal element with a predetermined force characteristic that spans the space between the molars on each side of the patient's jaw and provides force to expand at least one of the spaces between the molars on each side of the patient's jaw or the palate of the patient. The transpalatal element of the second virtual appliance can include a number of force control elements and/or regulating structures to control the force provided by the transpalatal element. The second virtual appliance can, in addition or alternatively, include a stop mechanism located on the shell to provide a mechanical force on the transpalatal element of the shell of the second appliance to reduce the force provided by the transpalatal element that expands the at least one of the space between the molars on each side of the patient's jaw or the palate of the patient. The transpalatal element of the shell of the second appliance, the force control elements, and/or the stop mechanism can be specific to a stage of a treatment plan and can be shaped based on physical data of the space between the molars on each side of the patient's jaw or the palate of the patient.

The virtual model of the dental appliance can, in some embodiments, be used to create a physical dental appliance. For example, dental appliance structural data can be stored in memory and used by an appliance manufacturing device to fabricate an appliance based upon the dental structural data. For instance, the memory can contain executable instructions to operate a thermoforming or direct fabrication device to form a dental appliance using those techniques.

In some embodiments, in order to direct force from the transpalatal element to other portions of the shell, a more rigid material may be applied between the transpalatal element and other portions of the shell (e.g., a rigid material is applied over and/or under the shell material or encapsulated within layers of shell material). Additionally, the rigid material used to form the transpalatal element can be reinforced by a reinforcement material (e.g., a metallic sheet or wire material).

As noted herein in some embodiments, the virtual appliance or data therefrom can be used to fabricate a physical appliance to be used in a patient's mouth. For example, in some embodiments, a method can include forming a physical transpalatal element based on the virtual transpalatal element.

It should be noted that when first and second are used to describe items in this disclosure, it is only meant that one item comes before the next and does not indicate that the items be the first and second items in a series of multiple items. For example, a first item may be the third item in a series of items and the second item may be the sixth item in a series and the terms first and second are used to indicate that the first comes before the second in the series even though there may be more items in the series.

Although specific embodiments have been illustrated and described herein, those of ordinary skill in the art will appreciate that any arrangement calculated to achieve the same techniques can be substituted for the specific embodiments shown. This disclosure is intended to cover any and all adaptations or variations of various embodiments of the disclosure.

It is to be understood that the above description has been made in an illustrative fashion, and not a restrictive one. Combination of the above embodiments, and other embodiments not specifically described herein will be apparent to those of skill in the art upon reviewing the above description. The scope of the various embodiments of the disclosure includes any other applications in which the above structures and methods are used. Therefore, the scope of various embodiments of the disclosure should be determined with reference to the appended claims, along with the full range of equivalents to which such claims are entitled.

In the foregoing Detailed Description, various features are grouped together in example embodiments illustrated in the figures for the purpose of streamlining the disclosure. This method of disclosure is not to be interpreted as reflecting an intention that the embodiments of the disclosure require more features than are expressly recited in each claim.

Rather, as the following claims reflect, inventive subject matter lies in less than all features of a single disclosed embodiment. Thus, the following claims are hereby incorporated into the Detailed Description, with each claim standing on its own as a separate embodiment.

What is claimed is:

1. A removable arch adjustment appliance, comprising:
a first plurality of tooth engagement structures shaped to mate with teeth of a patient along a first side of a dental arch;
a second plurality of tooth engagement structures shaped to mate with teeth of the patient along a second side of the dental arch;
a transpalatal element of the appliance configured to apply an expansion force via the first plurality of tooth engagement structures and via the second plurality of tooth engagement structures; and
a first regulating structure connected between the transpalatal element and the first plurality of tooth engagement structures, wherein the first regulating structure comprises a spring structure configured to distribute the expansion force from the transpalatal element evenly among molars corresponding to the first plurality of tooth engagement structures.

2. The appliance of claim 1, wherein the spring structure comprises a vertical or horizontal spring.

3. The appliance of claim 2, wherein the spring structure comprises a plurality of folds.

4. The appliance of claim 1, wherein the first regulating structure is configured to provide two degrees of freedom between the transpalatal element and the first plurality of tooth engagement structures.

5. The appliance of claim 1, wherein the first plurality of tooth engagement structures are configured to translate with respect to the transpalatal element via the first regulating structure.

6. The appliance of claim 1, wherein the first regulating structure is configured to dampen misalignment between the first plurality of tooth engagement structures and the transpalatal element.

7. The appliance of claim 1, wherein the appliance is configured to expand the dental arch and align one or more teeth of the patient simultaneously.

8. The appliance of claim 1, wherein the transpalatal element includes a variable cross sectional thicknesses.

9. The appliance of claim 1, further comprising a second regulating structure connected between the transpalatal element and the second plurality of tooth engagement structures, wherein the second regulating structure comprises a second spring structure configured to distribute the expansion force from the transpalatal element evenly among molars corresponding to the second plurality of tooth engagement structures, wherein the first spring structure comprises a first number of folds and the second spring structure comprises a second number of folds, the first number being different than the second number.

10. The appliance of claim 9, wherein the first plurality of tooth engagement structures, the second plurality of tooth engagement structures, the transpalatal element, the first regulating structure, and the second regulating structure form a unitary structure.

11. A method of manufacturing a removable arch adjustment appliance, the method comprising:
determining a virtual appliance for expanding a patient's palate based on an orthodontic treatment plan, wherein the virtual appliance includes:
a first plurality of tooth engagement structures shaped to receive teeth of a patient along a first side of a dental arch;
a second plurality of tooth engagement structures shaped to receive teeth of the patient along a second side of the dental arch;
a transpalatal element of the virtual appliance configured to apply an expansion force via the first plurality of tooth engagement structures and via the second plurality of tooth engagement structures; and
a first regulating structure connected between the transpalatal element and the first plurality of tooth engagement structures, wherein the first regulating structure comprises a spring structure configured to distribute the expansion force from the transpalatal element evenly among molars corresponding to the first plurality of tooth engagement structures; and
forming a physical dental appliance that corresponds to the virtual appliance.

12. The method of claim 11, wherein forming the physical dental appliance includes thermoforming a plastic over a physical dental model corresponding to the virtual appliance.

13. The method of claim 11, wherein forming the physical dental appliance includes at least one of computer-aided manufacturing (CAM) milling, stereolithography, 3D printing, fused deposition modeling (FDM), selective laser sintering (SLS), and photolithography.

14. The method of claim 11, the spring structure comprises a vertical or horizontal spring.

15. The method of claim 14, wherein the spring structure comprises a plurality of folds.

16. The method of claim 11, wherein the first regulating structure provides two degrees of freedom between the transpalatal element and the first plurality of tooth engagement structures.

17. The method of claim 11, wherein the first plurality of tooth engagement structures are configured to translate with respect to the transpalatal element via the first regulating structure.

18. The method of claim 11, wherein the first regulating structure is configured to dampen misalignment between the first plurality of tooth engagement structures and the transpalatal element.

19. The method of claim 11, wherein the transpalatal element includes a variable cross sectional thicknesses.

20. The method of claim 11, wherein the virtual appliance further includes a second regulating structure connected between the transpalatal element and the second plurality of tooth engagement structures, wherein the second regulating structure comprises a spring structure configured to distribute the expansion force from the transpalatal element evenly among molars corresponding to the second plurality of tooth engagement structures, wherein the first spring structure comprises a first number of folds and the second spring structure comprises a second number of folds, the first number being different than the second number.
